(19) United States
(12) Patent Application Publication
(10) Pub. No.: US 2014/0351693 A1
(43) Pub. Date: Nov. 27, 2014

(54) DOCUMENT PROCESSING AND NOTATING METHOD AND SYSTEM

(71) Applicant: PREPIT PTY LTD, Buderim, QLD (AU)

(72) Inventor: Linda Glassop, Buderim (AU)

(73) Assignee: PREPIT PTY LTD, Buderim, QLD (AU)

(21) Appl. No.: 14/357,710

(22) PCT Filed: Nov. 12, 2012
(86) PCT No.: PCT/AU12/01392

§ 371 Date: May 12, 2014

Related U.S. Application Data
(60) Provisional application No. 61/559,083, filed on Nov. 13, 2011.
(60) Provisional application No. 61/655,677, filed on Jun. 5, 2012.

(51) Int. Cl. G06F 17/21; G06Q 10/10; G06F 17/24; G06Q 10/06

(52) U.S. Cl. CPC G06F 17/211; G06Q 10/06; G06Q 10/10; G06F 17/24
USPC 715/235

(57) ABSTRACT

A method of creating a structured word processing document that is arranged in a specific format, the method comprising the steps of opening the document to be processed in one of a plurality of view types; creating one or more composition frames (C-frames), each C-frame (402, 404, 406) containing data inserted by a user and selected by the user based on the use of the C-frame (402, 404, 406) within the structured document; displaying the one or more C-frames (402, 404, 406) on a screen to enable editing or ordering of each C-frame (402, 404, 406) to compose the structured document; and formatting the structured document to a predefined format after completion of the C-frames (402, 404, 406).

### FIELD OF THE INVENTION

This invention relates to a word processing document system and method for creating a structured word processing document. In particular this invention relates to a system and method for electronically creating, writing and editing text and image compositions. The invention also relates to a system and a method for notating documents and media. In particular this invention relates to a system and method for electronically creating, writing and editing notations whilst reading an electronic document.

### BACKGROUND OF THE INVENTION

Writing is an activity that is undertaken by most human beings, whether it be for work, education or their own pleasure. There are a limited number of tools that are available to assist with the writing process. For convenience, in terms of storage, editing, displaying and formatting documents, electronic word processing software is predominantly used in order to write structured documents, for example, reports, academic essays.

A particular problem with current word processors is that they are substantially equivalent to one another, providing little differentiation by offering all applications to all people but not providing a specifically targeted set of applications to a particular user group, such as academics or business people. One of the early introduced word processing packages was Microsoft Word® originally developed in the 1990s. However the same principles that applied in the early 1990s generally apply with this package today and provides an outdated set of ideas. For academics and other users, the inability of word processors to separate writing from formatting causes a writer to constantly attend to formatting and styling their documents as they write. This distracts them from the important task of just writing. Furthermore, most current word processors do not approach writing as a project and do not provide project management tools.

There are numerous problems with current word processors and briefly each has at least two major faults. Firstly, they are generic, offering a large array of tools (for example mail merge, writing newsletters, invitations and other creative documents) to all kinds of users, for examples, children, mums and dads, consultants, academics and business people. Secondly, formatting occurs within the document as the user types rather than being applied to the document after the user has finished writing. As mentioned previously this distracts the writer from the foremost task of writing and the writer has to constantly reformat the document during the writing process.

Furthermore, within the word processing software, various soft copy templates are available. However, these templates are for style and design and are not content based. Templates in word format are very useful, however they are cumbersome to manage. For example, (a) moving from section to section can be difficult, especially if the document is long, (b) cutting and pasting sections can disrupt the style and formatting of the document, (c) scrolling back and forth between sections is tedious, and (d) accidentally deleting a section that is needed is another example which is cumbersome and unwanted.

There is also the issue of finding an appropriate template in the first place. Even when a template is found, the writer generally needs to amend the template to suit their own purposes. Such amendments are often stored by the user to be used as a future template for their specific work tasks. However, moving content from one document to another requires the user to become a “cut-and-paste” expert rather than focussing on the writing task at hand.

New and emerging technologies, such as mobile based applications, web based applications and drop-and-drag techniques provide a way of structuring writing for various type purposes to assist writers to write to academic standards. An academic standard does not prevent creativity in writing but can provide a structured way for a writer to prepare and present their thoughts. For example, most structured writing needs an introduction, a main body (usually in different sections), a conclusion and a reference list.

Academics produce research publications on a regular basis. Research articles must be formatted according to the style guide of the target academic journal. When the target journal changes, the style guide also changes which creates additional work for the academic.

The activity of conducting research work involves publishing the outcome of the research. Academic publications are required to be styled in the preference of the target academic journal. There are currently at least 20,700 academic journals across 19 disciplines worldwide which are peer-reviewed academic journals in the fields of arts and humanities, life sciences and medicine, social sciences and management and engineering and technology. There are around 3.7 million academics worldwide writing for academic journals and 40 million students writing academic papers at universities. Every academic discipline and journal has a different style guide to assist prospective authors. No matter how a research article has been written, an academic must format their end product, being the article, into the desired format of the target journal prior to submission. When an article is rejected by a journal editor, the author finds a different journal to submit their article and must reformat their article to the new style guide of the different journal. Changing the format of an article in current word processing systems is a manual process which is time consuming and cumbersome. Currently there exists no tool to support the academic writing process (with the exception of generic word processors) and manually reformatting text to different style guides. A range of tools exists to support bibliographic reference management (e.g. EndNote and RefWorks) and most reference software interfaces with the main word processors. However these tools are generally cumbersome to use.

Furthermore, research workers often use special terms such as abbreviations, acronyms, glossary terms and symbols in their writing related to their field of endeavour. Current word processors have no means for capturing, storing, retrieving or automatically listing these special terms in certain documents, such as a dissertation, manuscript or research report.

Furthermore, research workers have no means for tracking a range of work tasks associated with their writing, be it the overall composition or individual parts of the composition. For example, who is writing which component of the composition and what is the status of each component, for example is it at a “draft” stage, a “to review” stage, or has it been “completed”? Other work tasks include what items of work still need to be done, that is, for example, “find a citation” or “add a table”; writing notes about the composition (e.g. memory joggers about what to include); tracking follow up reminders (e.g. check with colleagues on a date) and keeping a track of emails sent about the composition, for example to a colleague or a journal editor. All of these particular features are not possible with current word processing packages.

Formatting or styling a document is a different task from writing a document. The current word processors require the user to focus on both tasks simultaneously, often the styling or formatting can overshadow the writing. As an example, if a user changes a particular style for a paragraph, then they must select all paragraphs before making the style change so that they are all consistent. However, if another style has the initial paragraph styling embedded in it, then the task becomes messy and difficult. If a user adds figures, lists or tables or other objects to their document, the formatting (e.g. number outline) can get confused and the writer then spends more time and energy trying to get their document to look consistent compared to actually writing the document. There is simply no existing process that allows an entire document to be formatted (or reformatted) to a specific style. Also, the inability to move text around a document with ease requires the user to cut-and-paste. While drop-and-drag is useful, if a user fails to highlight text correctly then the task must be undone and attempted again. Also, current to word processors do not have the ability to assign sections of a composition or article to different writers, link discrete sections to specific tasks nor allow viewing a composition based on who is writing a particular section of that composition.

Reading is a task undertaken by most able human beings. Today, reading has moved from being associated with hardcopy paper-like documents (e.g., books, newspapers, journals, etc.) to online reading objects such as eBooks, portable document files (pdf), web-based pages, and other forms of media.

A particular problem exits for readers of electronic reading material. When in hardcopy form, a reader, in particular a student or researcher, can highlight text or add notes easily with a highlighter pen and/or pencil. Current electronic reading tools allow for this kind of simple note-taking (highlighting text, writing notes or making graphic objects such as a circle). For example, Adobe® provides the following annotation tools: pencil, highlight marker, straight lines, underline, strike out, rectangles, ellipse, stamper (add a check mark, arrow, star or cross) and text box (to add notes). Other software providers have included freehand lines and writing. However, a student or researcher typically creates specialised notes as they read, such as: identifying text to use as a quote, preparing paraphrases, cross-referencing other reading material, making glossary entries, and the like, by preparing manual notes, often in a note-book or using scraps of paper or sticky notes.

Furthermore, the term ‘annotate’ generally refers to a reader being able to identify the usefulness of what they are reading for developing an argument of their own. Typically, annotation in software provides graphic mark-up capability (drawing lines, etc.) rather than the ability to notate the usefulness of what someone is reading.

Furthermore, manual note-taking is often organised along the lines of a particular research project, and sorting such notes can be a time-consuming, clumsy and a difficult task. Thus, the research process is delayed by ineffective and inefficient note-taking options.

Furthermore, students are taught the art of writing and researching when they attend university, college or some other educational institution. A key aspect of learning the research process is the ability to digest reading material and create specialised notes such as quotations and paraphrases that meet academic standards by not infringing copyright laws. Plagiarism is a particularly prevalent issue for non-English speaking students in English-speaking universities and colleges as they have often been taught to respect the words of their Professors and the like by repeating what they say rather than paraphrasing. Thus, plagiarism software (e.g., TurnitIn®) has become the tool of choice for academic institutions wishing to police poor writing practices; rather than provide reading tools that assist a student with the task of researching while they read.

The present invention seeks to overcome one or more of the above problems by providing an improved document processing system and providing an improved reading notation system for electronic documents and media.

### SUMMARY OF THE INVENTION

According to the first aspect of the invention, there is provided a method of creating a structured word processing document that is arranged in a specific format, the method comprising the steps of:

opening the document to be processed in one of a plurality of view types;

creating one or more composition frames (C-frames), each C-frame containing data inserted by a user and selected by the user based on the use of the C-frame within the structured document;

displaying the one or more C-frames on a screen to enable editing or ordering of each C-frame to compose the structured document; and

formatting the structured document to a predefined format after completion of the C-frames.

The method may further comprise naming each C-frame and displaying the name of each C-frame on a portion of the screen to enable the user to select and display a desired C-frame. The one or more C-frames may be selected from a range of types; for example, basic writing frames, helper frames, saved frames, automatic frames, multi frames and miscellaneous frames, said types of frames being selectable through a respective button, tab or module displayed on a screen.

The method may further comprise displaying the status of one or more C-frames and coding each of the C-frames to indicate said status. The method may further comprise assigning one or more writers and/or one or more reviewers to a C-frame, such that said one or more writers and/or one or more reviewers are responsible for the content and completion of the C-frame. A user can elect one of the view types of a C-frame assigned to a specific writer, a specific reviewer, a number of writers or a number of reviewers.

The plurality of view types may include an Outline View in which the name of each C-frame is displayed in a first window and a Stack View in which the content of selected C-frames is concurrently displayed in a second window. The plurality of view types may include a Writing Plan View in which C-frames are displayed horizontally across the screen to enable a user to plan the structure of the document including editing and moving the C-frames.

According to a second aspect of the invention, there is provided a computer-readable medium comprising computer-executable instructions that, when executed on a processor, in a method of creating a structured word processing document that is arranged in a specific format, directs a device to:

open the document to be processed in one of a plurality of view types;

create one or more composition frames (C-frames), each C-frame containing data inserted by a user and selected by the user based on the use of the C-frame within the structured document;

display the one or more C-frames on a screen to enable editing or ordering of each C-frame within the structured document; and

format the structured document to a predefined format after completion of the C-frames.

According to a third aspect of the invention, there is provided a system for creating a structured word processing document that is arranged in a specific format, said system comprising:

a server having a processor and memory for storing computer-executable instructions;

one or more computing devices linked to said server through a communications network;

wherein a user or users of said one or more computing devices are able to access said server to create said document by:

creating one or more composition frames (C-frames), each C-frame containing data inserted by a user and selected by the user based on the use of the C-frame within the structured document;

displaying the one or more C-frames on a screen to enable editing or ordering of each C-frame within the structured document; and

formatting the structured document to a predefined format after completion of the C-frames.

According to a fourth aspect of the invention, there is provided a method of notating a document electronically by a user while reading the document, comprising the steps of:

accessing and displaying in a first window the document for notation on an electronic display means;

selecting a portion of the document;

providing in a second window associated with the selected document portion, one or more links to characteristics of the selected document portion; and

displaying each characteristic for viewing, editing or notating by the user.

According to a fifth aspect of the invention, there is provided a computer-readable medium comprising computer-executable instructions that, when executed on a processor, directs a device to perform any one or more of the steps of the fourth aspect.

### BRIEF DESCRIPTION OF THE DRAWINGS

A preferred embodiment of the invention will hereinafter be described, by way of example only, with reference to the drawings in which:

FIG. 1 is a block diagram of a communications system that enables the creation of a structured word processing document;

FIG. 2 is a block diagram of hardware associated with computing devices or the server depicted in FIG. 1;

FIG. 3 is a block diagram showing the various modules of the software that enables the creation of the document;

FIG. 4A is a screen diagram of a document to be created shown in an Outline View;

FIG. 4B is a screen diagram showing a document being created with composition frames and frame headings on the screen in an Outline and Stack View;

FIG. 4C is a flow diagram showing the creation of a document from start to finish including applying or modifying style guides to a document after is has been composed;

FIG. 4D is a flow diagram showing the steps involved in the selection of a resource document and annotating a portion of the selected document;

FIG. 4E is a screen showing various sections of a resources screen used to select the resource document and annotate or notate the document;

FIG. 4F is a screen showing a portion of a document with reference data of the document shown in a Notebook section of the screen;

FIG. 4G is a screen showing a portion of the document shown in FIG. 4F with text highlighted and a box with links to characteristics of the selected text, the characteristics being shown in the Notebook section of the screen together with a rank and use;

FIG. 4H is an enlarged screen showing the box in FIG. 4G with links to the characteristics;

FIG. 4J is a screen similar to FIG. 4G showing a number of selected resources and associated annotations contained therein;

FIG. 4K is a screen showing a portion of the document shown in FIG. 4F with information on tags used in relation to the document and shown in the Notebook section;

FIG. 5A is a menu providing access to different views available for a document;

FIG. 5B is a menu showing access to parts of a tools database;

FIG. 5C is a menu showing parts of a resources database that can be accessed;

FIG. 5D is a menu of writing frames;

FIG. 5E is a menu for multi-frames;

FIG. 5F is a menu for helper frames;

FIG. 5G is a menu for saved frames;

FIG. 5H is a menu for automatic frames;

FIG. 5J is a menu for miscellaneous frames;

FIG. 5K is a window for entering or amending metadata for a document;

FIG. 5L is a window providing access to a user to insert various data in the document;

FIG. 5M is a screen showing access to a header and footer for a document section;

FIG. 6 is a screen diagram showing a document in a Writing Plan View;

FIG. 7 is a screen diagram showing the document in a Preview View;

FIG. 8 is a flow diagram showing Tasks that can be added or modified to a document, such as status of the document, the writer, a to-do reminder, placeholder reminders, notes and emails;

FIG. 9 is a menu showing the status of a composition frame within a document and the assignment of writer/s and reviewer/s;

FIG. 10A is a menu showing the selecting of writers assigned to parts of a document, for example particular composition frames;

FIG. 10B is a window displaying all of the assigned writers or people associated with a particular C-frame;

FIG. 11 is a window for adding or modifying a to-do reminder;

FIG. 12 is a window showing a placeholder that can be created or modified;

FIG. 13 is a window for adding or modifying a note about a composition frame within a document to remind the writer;

FIG. 14 is a window providing email messaging between writers on a composition frame or document or people that need to review the document;

FIG. 15A is a menu that provides access to a terms database to assist in constructing or amending a document;

FIG. 15B is a window displaying the long and short versions of an acronym;

FIG. 15C is a menu of an index of various topics, places, names and organisations;

FIG. 15D is a menu associated with a recurring field in the document;

FIG. 16 is a flow diagram showing the process for producing an automatic listing of a term;

FIG. 17 is a box displaying the automated output for a list of acronyms;

FIG. 18 is a flow diagram showing the process of selecting and applying a style guide to a completed document;

FIG. 19 is a menu providing access to various predefined document and bibliographic style guides or the ability to create a new style guide;

FIG. 20 is a screen diagram of composition style guide requirements;

FIG. 21 is a screen diagram showing bibliographic reference style guide requirements;

FIG. 22 is a block diagram and flow diagram showing the activities associated with composing, writing and editing a document; and

FIG. 23 is a screen diagram of files that can be accessed through a file manager associated with the system.

### DETAILED DESCRIPTION OF THE PREFERRED EMBODIMENT

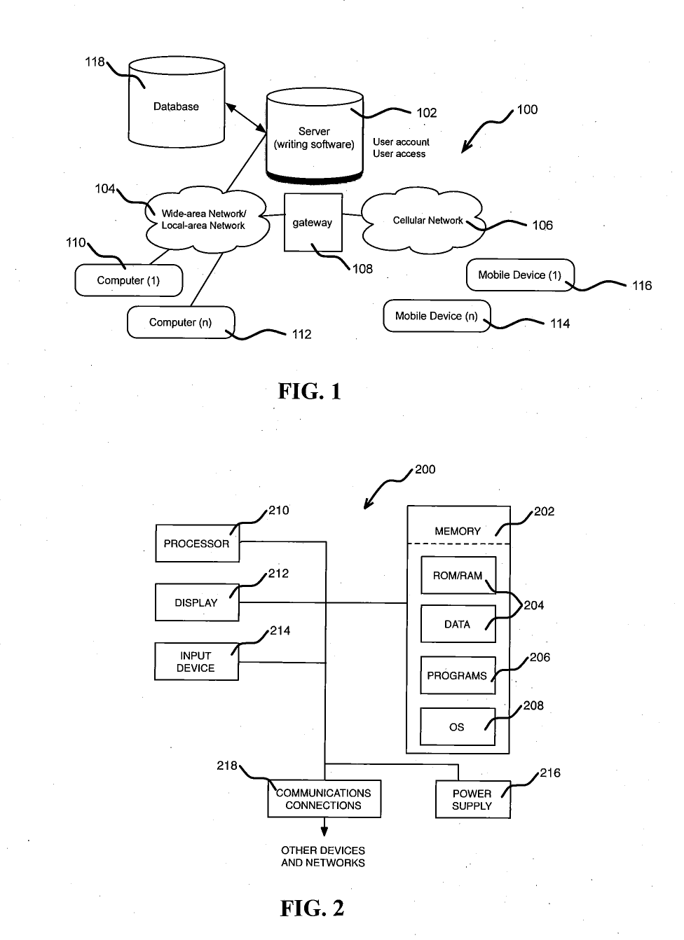

Referring to FIG. 1 there is shown a block diagram of a communications system (100) that is used to create and amend a composition (document) electronically. The computer program used to construct a composition is stored in memory of server (102) or alternatively in a library or database (118). Separate computing devices (110, 112) are linked to the server (102) over a communications network (104) that may be a WAN or LAN. Mobile computing devices (114, 116) are linked by cellular network (106) through a gateway (108) to the network (104) in order to gain access to the server (102).

Shown in FIG. 2 is a block diagram of hardware typically associated with any of the computing devices (110, 114) or the server (102). The hardware (200) includes a memory (202) which includes ROM/RAM as well as stored data (204), programs and applications (206) and an operating system (208). The memory is linked to a central processor (210), a display unit (212) and an input device (214), such as a keyboard, touch pad or mouse. A power supply (216) provides power to these units. A communications connection (218) also serves as a port to other devices and/or networks.

Each of the screens, menus or windows shown in any one of the Figures, including access to modules, buttons, tabs, links are provided by the computer program or software stored in memory (202) of server (102) and any of the devices (110), (112), (114) or (116) and accessed, run or processed by central processor (210) or equivalent processor on each of the devices (110), (112), (114) or (116), in accordance with the instructions provided by the computer program.

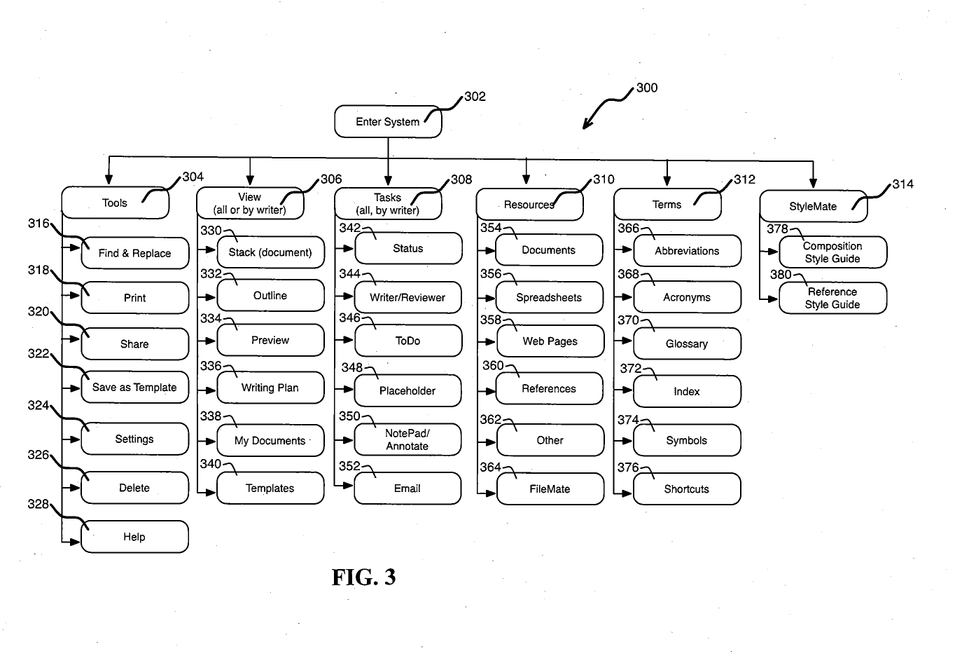

Referring to FIG. 3 there is shown a block diagram of the various modules or components that the composition software provides. These modules can equally be described as functions or applications. The diagram (300) provides entry to six major functions through an entry module system (302). The six major functions or modules are a tools menu (304), a view menu (306), a tasks function (308), a resources database (310), a terms database (312) and a document style guide function (StyleMate) (314). Each of the various sub menus or sub modules will be described at various parts of the description hereinafter.

All of the modules are accessible by computer programs stored in either the memory of server (102) or a respective computing device (110), (112), (114), (116). All of the module functions to be hereinafter described can be executed by the computer programs (computer-executable instructions), when executed on a processor in the server (102) or in respective computing devices (110), (112), (114), (116).

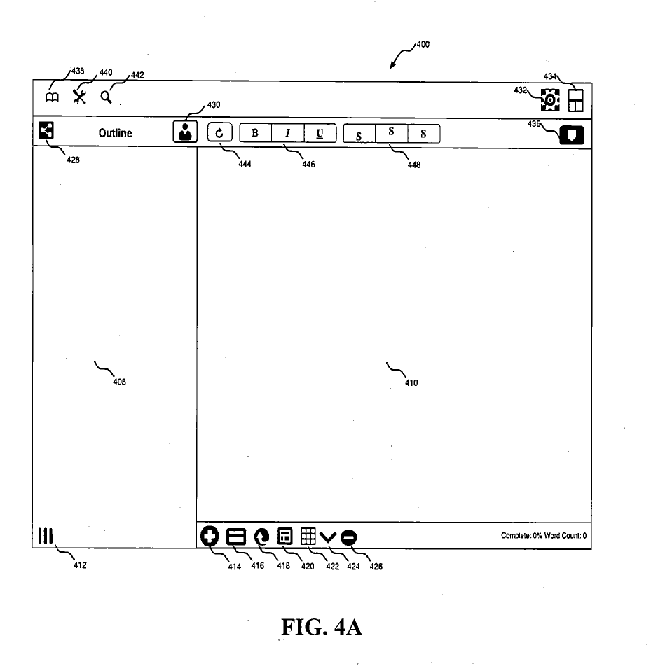

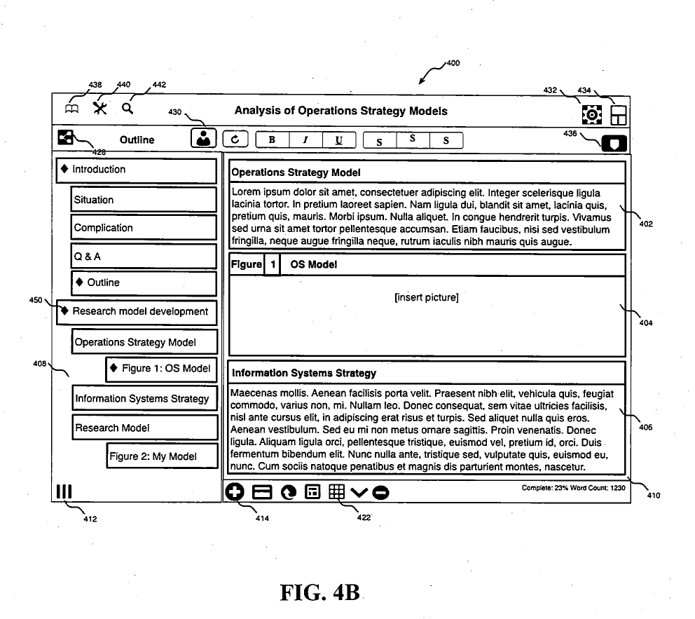

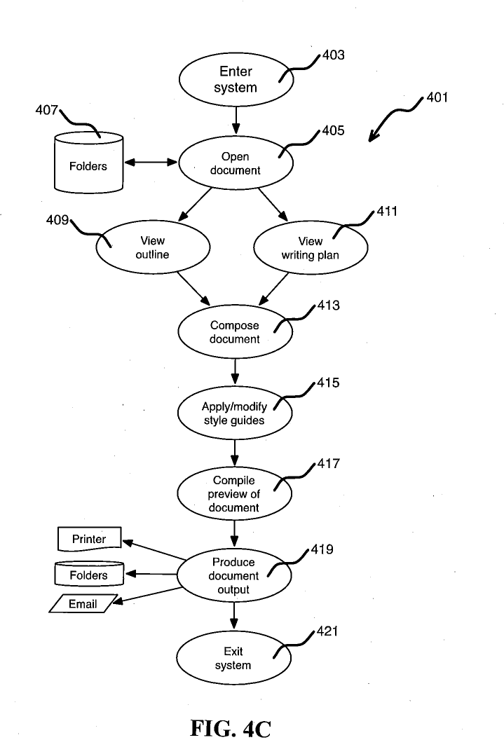

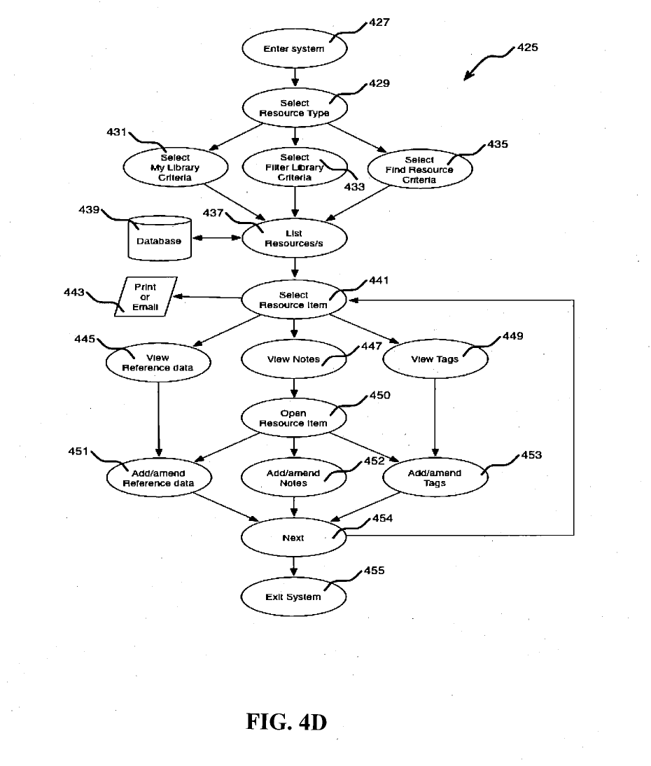

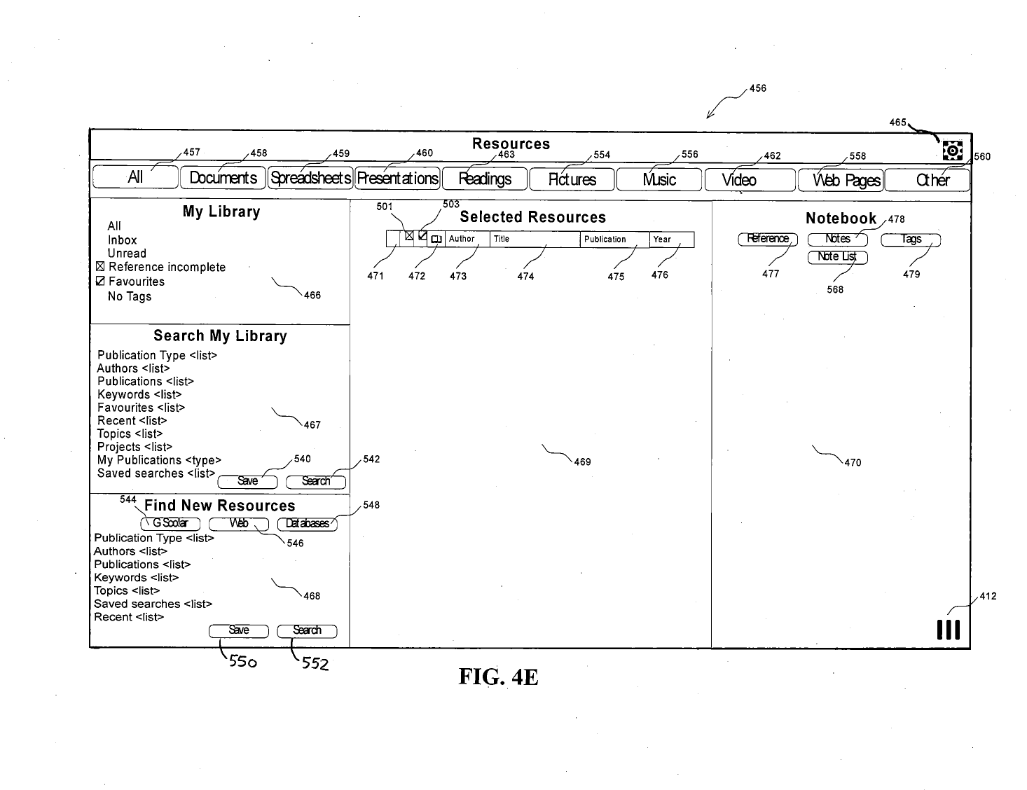

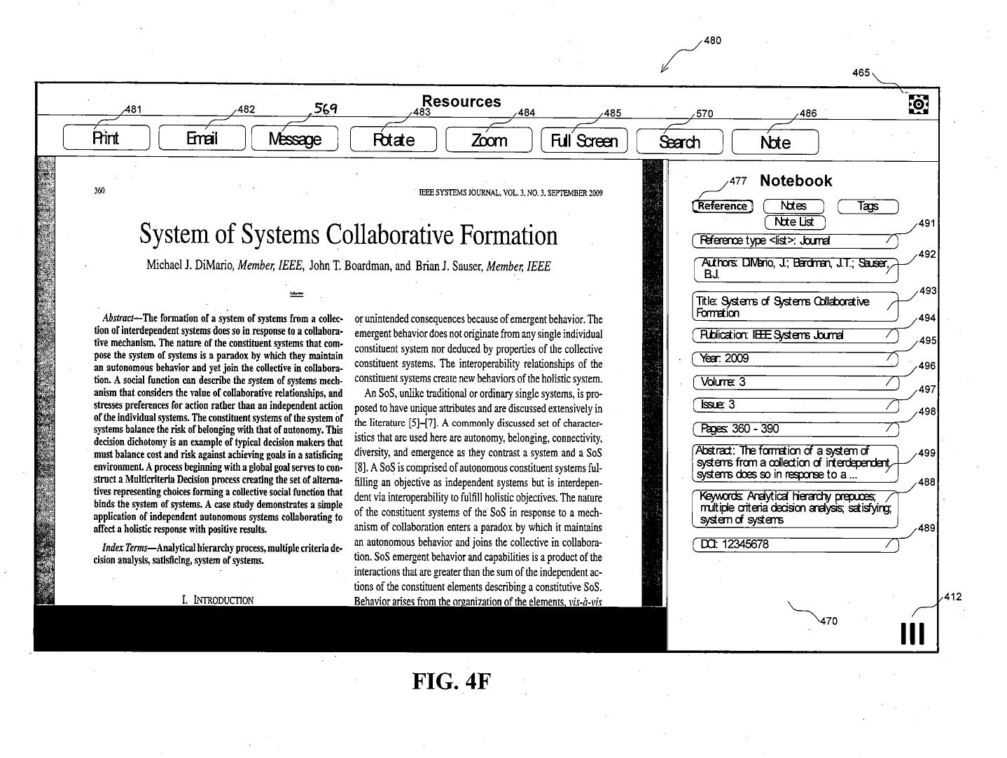

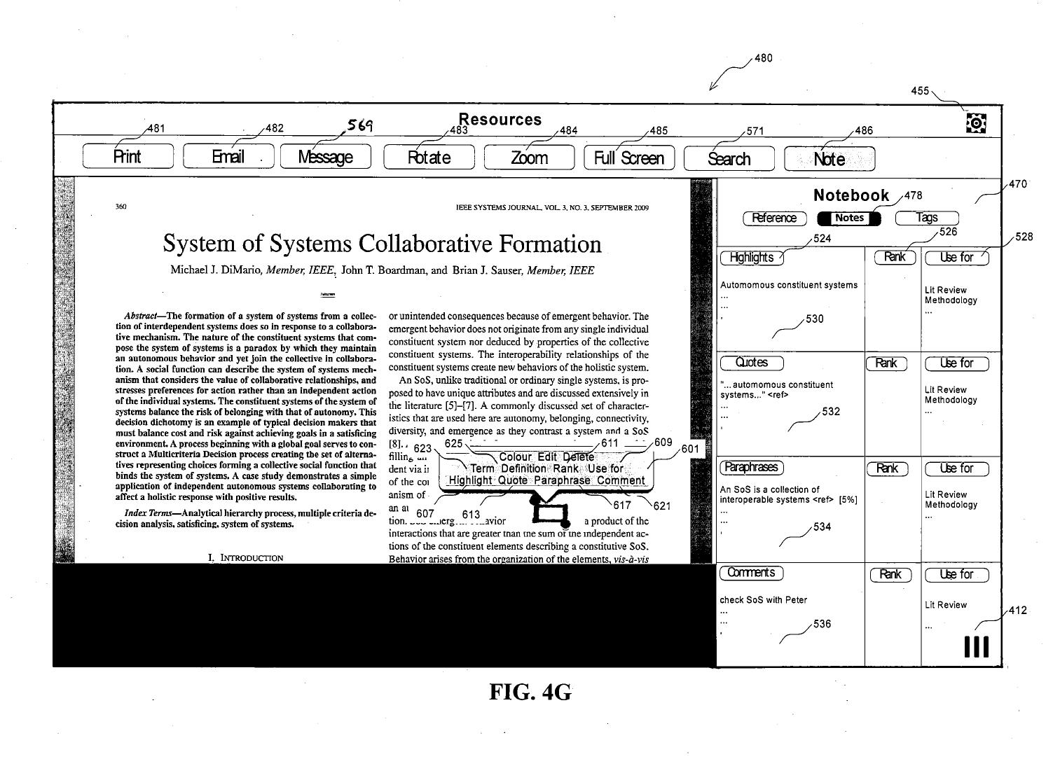

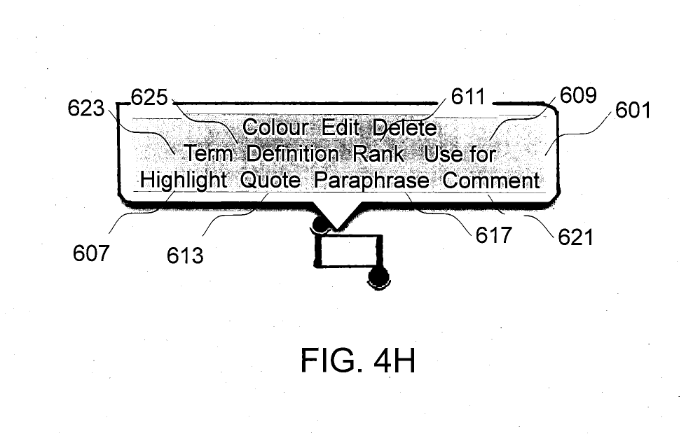

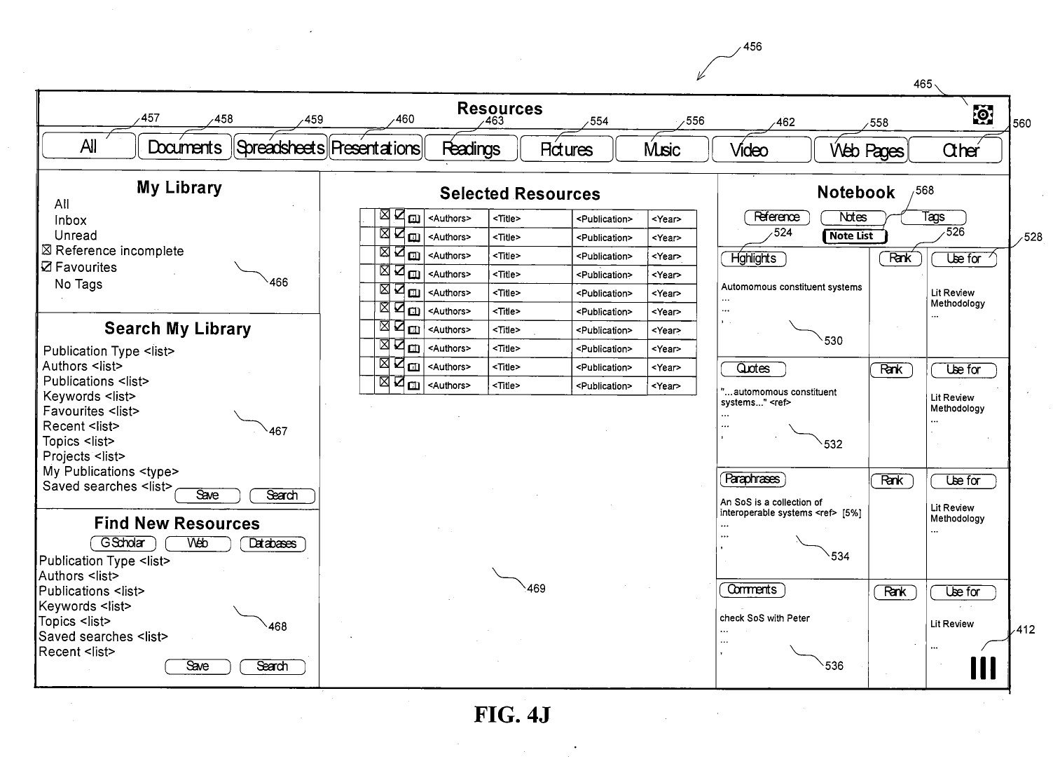

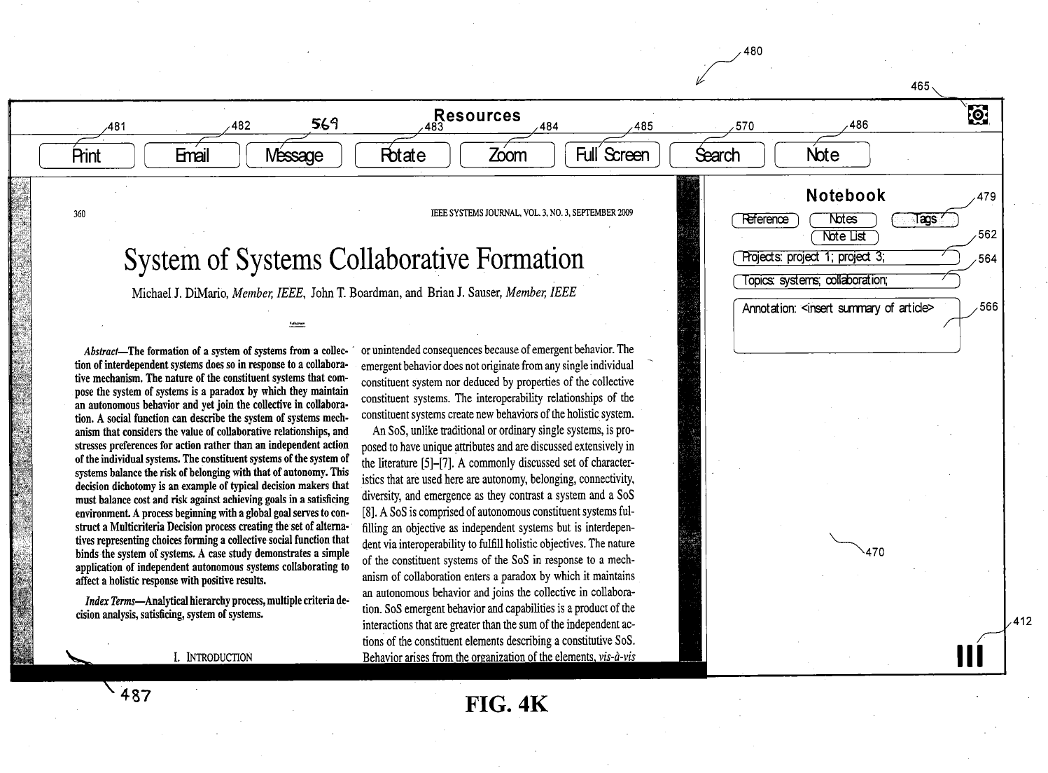

The view module (306) enables various ways of viewing a composition and allows the user to access composition frames (hereinafter referred to as C-frames) through each of the outline view (330), the stack (document) view (332), the preview view (334) and the writing plan view (336). A composition frame (C-frame) is a discrete object that holds captured text and/or objects that is used to compose part of a document. A series of user-selected C-frames are added to the composition in order to compose the required document. Examples of composition frames are shown in FIG. 4B at (402), (404) and (406). FIG. 4B shows the outline view and stack view as is FIG. 4A which does not have any C-frames added. C-frames can be added, moved, saved and deleted and each C-frame Task can be edited in each of the Writing Plan, Stack and Outline Views. C-frames can be edited in the Stack View and the Preview View (that shows the C-frame content automatically formatted based on the style guide). In the Stack View (410) the user is able to view all C-frames in a sequential order, add C-frames (414) to (426), edit C-frames and change the order of C-frames. The Stack View (410) is the primary working area in the system for adding C-frames and content to a composition.

Composition frames (for example, (402), (404), (406)) contain discrete elements such as a heading, a list, a paragraph, a statement, a caption, a title or a table. Each C-frame is ordered to compose a specific type of composition, for example, a journal article, report or business plan and can be reordered, by drop-and-drag technique, within the current composition. The C-frames come in various types including 1, 2 or 3 part, multi-lined, layered or data and have options that indicate their characteristics and behaviour based on their use within a composition. Each C-frame is named based on their use within a composition, for example: heading+paragraph, list, hypothesis, formulae, indented quote, figure, table, caption, data, etc. They can also be named by the user to suit the user's composition preferences, for example, company history, a person's biography, copyright notices. C-frames are reusable in other compositions, with or without content, and can be saved and retrieved with reusable content. Each C-frame can be altered to become a different composition frame and they can have numerous format styles associated with each according to different style guides. The C-frames are each compiled to form an output file (document), in various forms that can be saved, printed and emailed.

A series of composition frames can be saved, as a composition, to represent a template for future use, such as a business proposal template, an essay template, a letter or email. C-frames can be linked together to form multiple composition frames to aid with the writing task. As an example, the following have C-frames that are linked together: cover page, copyright page, document history page, structured abstract, introduction helper, paragraph helper, conclusion helper, list, tables, figures, complex headers, complex footers.

Some features for altering text can be made within each C-frame such as copy, cut, paste, highlight text as bold, italics or underline (446), highlighting in colour, inserting symbols and inserting subscripts, superscripts and strikethroughs (448).

C-frames enable the addition of notations (436) into each frame, the addition of stored data, such as in a terms database (312), and have tasks (308) associated with each frame, such as status, writer/reviewer name, placeholders, to-do items, notes/annotate, history or audit trail. Composition tags or C-tags (424) can be positioned between frames to enable, for example, a forced page break, adding a blank page, and changing page orientation. Each C-frame allows a user to document associated tasks (308) such as:

(1) The status (342) of the C-frame, which can be colour coded to indicate that the frame has not been started, is in a draft mode, has been finished or is yet to be reviewed. The C-frames shown on the screen (400) and in some of the other views, such as the Writing Plan View, shows the particular status by the colour of the frame.

(2) Who is responsible for writing or reviewing (344) each C-frame. A user can click to edit the writer name or to link to a contacts file.

(3) A list of Placeholders (348) included in the C-frame, which are automatically generated and outstanding placeholders are highlighted by a symbol (450)

(4) The ability to add a “to do” item (346) linked to a calendar entry in order to remind the writer about a particular task.

(5) The ability to record a note or annotation (350) about a particular frame which can be edited.

(6) The history (444) to show what changes have been made to the frame which includes the date it was created, edited and any changes made and by whom. A window can be accessed from within the document that depicts a history slider or bar. It provides a timeline of revisions or amendments made to the document that can accessed and viewed by clicking on a link to revert to that particular document version. It indicates who made the revision or changes, when it was made and the size of the document. Other characteristics of the document can be included.

There are various kinds of composition frames including basic writing frames, multi frames, helper frames, auto frames, saved frames and miscellaneous frames and C-Tags for including, for example, a forced page break. Other kinds of C-frames may yet be determined.

As mentioned previously FIG. 4A is a screen diagram of the outline view that is used to compose, amend and rearrange C-frames. The screen (400) includes an outline view window (408) which is used to display headings of the document and a stack view window (410) which is used to display the C-frames. In window (410) frames can also be added and the C-frame content within each frame edited. Window (408) essentially displays the names of each frame and allows access to each frame by clicking on the heading which is then displayed in box (410). A three strike button (object or icon) (412) at the bottom left hand corner of screen (400) enables the user to hide the outline view. Also located at the bottom of the screen (400) are buttons that enables a user to add and work on different types of frames, in this instance a basic writing frame (414). Button (416) provides access to helper frames while button (418) provides access to saved frames. Button (420) provides access to automatic frames and button (422) provides access to multi frames. Button (424) provides access to miscellaneous tags and button (426) enables the deletion of a frame.

Referring to FIG. 4B, touching and dragging any one of the headers in window (408) will enable a user to move that header around the screen (400). It will also select the outline and jump to that position in the document. Thus by a user touching or clicking on the “complication” heading, for example, will enable any content that is under that heading to be displayed in window (410). Clicking on button (428) enables editing tasks to be performed on any one or more of the C-frames. The top part of the outline area in the screen (400) is also selectable and tasks can be managed by clicking on this section for the whole document.

A custom keyboard, that can appear on the screen (400), can be used by the user and will be able to have access to customised characters and symbols. Frames can be inserted either at the bottom or between frames, nested within the current frame. Words with incorrect spelling or sentences with incorrect grammar will have red and green lines thereunder. Touching a word or a sentence will bring up a menu with suggestions. Diamonds, or any other suitably shaped indicia, (450) that are indicated at the left side of any one of the headings in window (408) indicate that there are still “to-dos” or Placeholders active. The colour of any one of the headings indicates the status of that frame.

Referring to FIG. 4C, there is shown a flow diagram (401) of the overall process that the system undertakes, under instruction from the computer program. It shows that the writing or compose process is distinctly different from the formatting (style guides) process. At step (403) the user enters the system and at step (405) opens the required document. This document can be obtained from the folders database (407). At (409), the outline view is obtained or alternatively the writing plan view is obtained at (411). The document is then composed at step (413) and at step (415) style guides are applied or modified. At step (417) a preview of the document output is compiled by applying a style guide (415) to a document composition (413) and then at step (419) a document output is produced which can be printed, emailed or saved in a folder (407). The system is then exited at step (421).

With reference to FIG. 4D there is shown a flow diagram that enables access to electronic reading material and note-taking options in relation to an electronic resource. The flow diagram (425) starts by the user entering or accessing the system at step (427). At step (429) the user accesses a resource type from the resources module (310). The user can select a resource from “My Library” at step (431), a resource from “Filter/Search My Library” at step (433) or select a resource from “Find New Resource” at step (435). Once a selection has been made the process moves to step (437) where the selected resource or resources is/are displayed, for example, in window (469) of FIG. 4E on screen (456). The resources listed are retrieved from the database (118) in FIG. 1. The user then selects a resource item at step (441) and has the option to print or email the selected resource item displayed at step (443).

Using the screen (456) or (480), the user can view any reference data at step (445), view any notes at step (447) or view tags at step (449) relating to the selected resource. When viewing notes, the user can open the resource item at step (450) and then add or amend reference data at step (451), add or amend the notes at step (452) or add or amend tags at step (453). If viewing the tags at step (449) the user has the option to add or amend the tags at step (453). If viewing the reference data at step (445) the user has the option to amend or add reference data at step (451).

After the reference data, notes or tags have been amended or added, the process moves to step (454) where the user has the option to select another resource item back at step (441) and undertake the same process of steps (445) to (453). Otherwise the user can exit the system at step (455).

Referring to FIG. 4E, there is shown a screen (456) which depicts the resources page. The page is split up into various sections being “My Library” (466), “Search My Library” (467), “Find New Resources” (468), window (469) for displaying the selected resources and window (470) displaying notebook features. The user can select one of the criteria in “My Library” (466) to retrieve all resources, those that are unread or have a reference incomplete, one of the favorites or one with no tags or one from an inbox. Each of the resources retrieved under each category are listed in box 466. The user can also select “Search My Library” (467) to access publication type, authors, publications, keywords, favourites, recently retrieved resources, topics, projects, My Publications and Saved Searches. The search is performed by clicking on Search button (542). Each of the resources retrieved under each category are listed in box 467. Save button (540) is used to save any data searched. In the “Find New Resources” section (468) the user can search databases through tab (548), the web through tab (546), or a scholar reference through tab (544) based on any one of the headings: Publication type, Authors, Publications, Keywords, Topics, Saved Searches and Recently Accessed Resources. The buttons Save (550) and Search (552) are used. Each of the resources retrieved under each category are listed in box 468.

Any selected resources are then displayed in window (469) where each resource will have listed the author in field (473), title of the resources in field (474), the publication details in field (475) and the year it was published in field (476). Each of boxes (471), (501), (503) and (472) are check boxes used to indicate respectively whether or not the reference/resource has been read, if the reference data is complete, if it has been added to “favourites”, and if the reference has any tags.

On the right hand side of the screen in window (470) is listed the notebook module where one can access the resource Reference data through tab (477), Notes through tab (478) or Tags through tab (479) pertaining to the selected resource. A Note List tab (568) provides access to and displays the notebook view/window shown in FIG. 4J. At the top of the screen the user can access various tabs to all resources by clicking on tab (457), documents at tab (458), various spreadsheets at tab (459), to presentations at tab (460), readings at tab (463), pictures at tab (554), music at tab (556), videos at tab (462), web pages at tab (558) and other information or resources at tab (560). Icon (465) takes the user to the Settings Module.

With reference to FIG. 4F, a resource has been accessed which is shown in window (487), being a journal article. The user has opted to view the reference data by clicking on tab (477) which displays information in boxes (488) to (499) pertaining specifically to the displayed resource in window 469. Thus in box (491) there is displayed the reference type being a journal, in box (492) the authors and in box (493) the title. In box (494) there is displayed the publisher details, in box (495) the year the reference was published, in box (496) the volume number, and in box (497) the issue number. The page numbers are listed in box (498) while in box (499) there is displayed an abstract of the journal. Keywords are also listed in box (488) while a DOI number is listed in box (489). The user may edit any one of these boxes or amend the data.

Referring to FIG. 4G there is shown a highlighted portion of text (FIG. 4H) in the window (487) that displays the journal. When highlighted, a box (601) appears above the highlighted portion with options for the user to access including colour, edit, delete, term (623), definition (625), rank (611), use for (609), highlight (607), quote (613), paraphrase (617) and comment (621). The user can select any one of these functions for the highlighted text which will automatically appear in the window (470).

Clicking on the notes tab (478) produces each of the fields shown on the right hand side in window (470). Thus in column (524) there is a highlights section (530) which lists any text which has been highlighted from the journal in window (487), any quotes in quotes section (532), any paraphrases entered by the user in paraphrases section (534) and any comments made and entered by the user in comments section (536). Each of these fields are editable. Alongside each of the sections (530), (532), (534) and (536) in column (526) there is provided a rank figure of the importance of each of the highlight, quote, paraphrase, or comment for a particular writing project. The user enters indicia, such as the stars shown in the Figure, to indicate the relative importance. The more stars added, the higher the ranking is. Any other suitable ranking system can be used. In the last column (528) a “use for” section is provided to note potential uses of each of the highlights, quotes, paraphrases or comments and this is entered by the user.

A particular paraphrase or quote or highlight can be compared with one another to derive a similarity percentage based on a number of words or type of descriptors in each of the text or captured passages as shown in section (534). Options are provided at the top of the screen (480) to print a document through tab (481), to email the document to another person through tab (482), to rotate the view through tab (483), to access or send a message at tab (569), to zoom in and out through tab (484), to provide a full screen for the journal article using tab (485), to undertake a search at tab (570) or to take notes using tab (486).

Referring to FIG. 4J there is shown a further resource page (456) where a number of resources have been selected in window (469). On the right hand side in the note book window (470) accessing “Notes List” tab (568) produces the option to list highlights, quotes, paraphrases and comments for all selected resources as in FIG. 4G.

Finally in FIG. 4K there is shown screen (480) where the user clicks on the tag button (479) in the notebook window (470). It lists projects in box (562), topics in box (564) and any annotations or summary of articles in box (566). All of these fields, (562, 564 and 566) are editable.

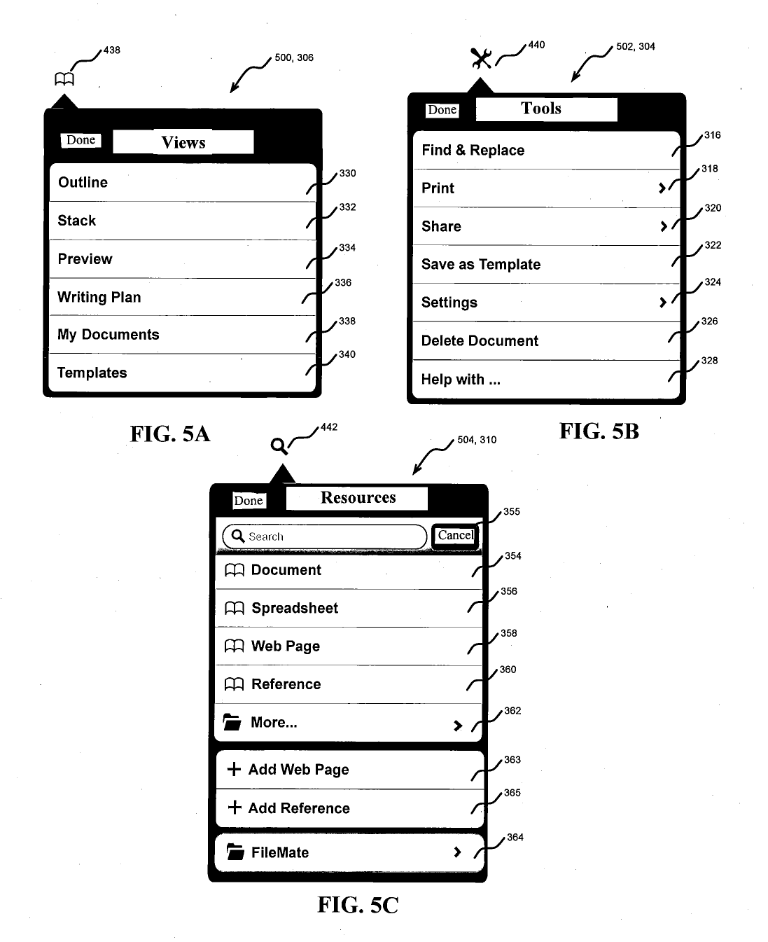

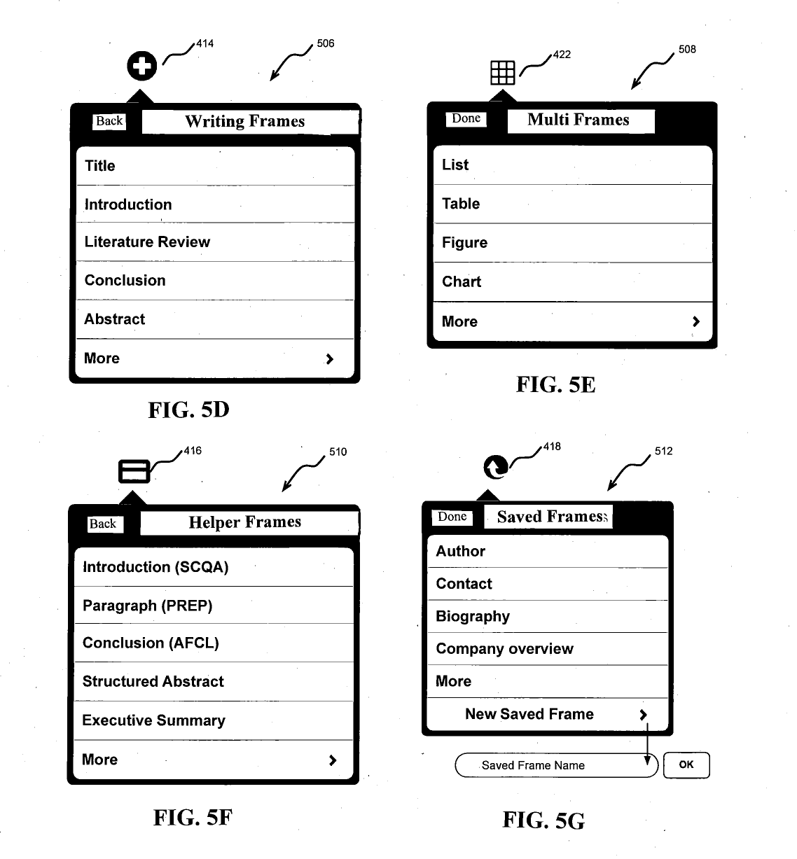

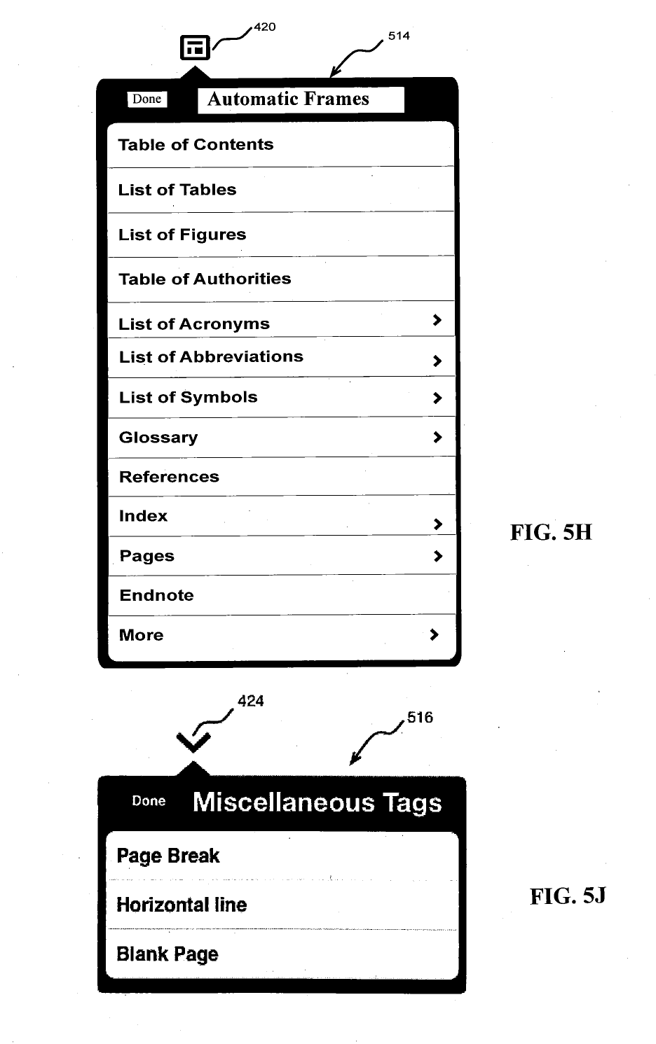

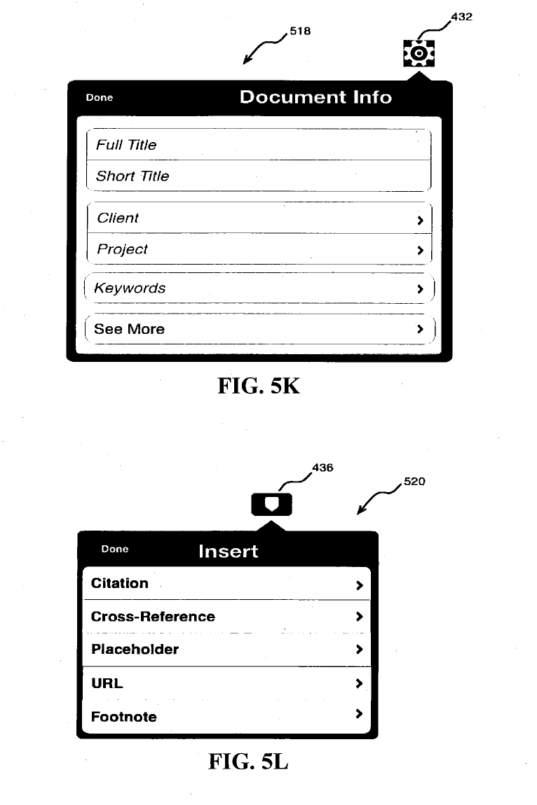

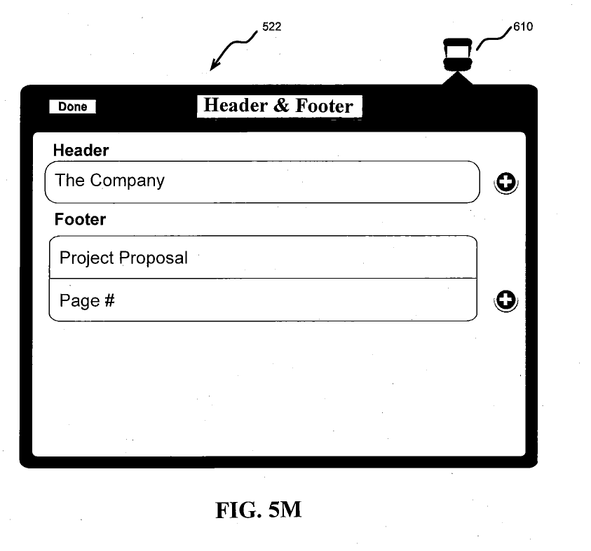

Returning to FIGS. 4A and 4B, button (430) which displays a person, is used to change the view to a specific writer or reviewer. The wheel button (432) is used for editing the document metadata. Button (434) is used to access various style guides to be applied to C-frames in the document. The down arrow box or button (436) is used for inserting items into frames, such as media, Placeholders, citations and resources. Button (438), which depicts an open book, provides access through module (306) to various views and documents, such as Outline, Stack, Preview, Writing Plan, My Documents and Templates as seen in the menu (500) of FIG. 5A. Button (440), which depicts a spanner and screwdriver, is a Tools program, accessed through module (304), which is shown more clearly in menu (502) of FIG. 5B. This enables a user to Find and Replace Text (module (316)), Print (module (318)), access Settings (module (324)) and Help (module (328)). The “Save As” Template option (module (322)) will bring up a field above the keyboard or screen, like Find and Replace. Share (module (320)) provides options of emailing a C-frame, a selection of C-frames, an entire document or providing access to the document by another person. The Help option (module (328)) is contextual to the current screen or frame selection. From the Help window it is possible to see a general overview. Other editing functions include “Hypothesis”, “Proposition”, “New Caption Label” and “Remove Caption Number”.

Button (442) is a Resources button accessed through module (310), which upon clicking provides the menu (504) shown in FIG. 5C. Resources allow the user access to all kinds of private documents that are stored and synchronized on line and on a portable electronic computing device such as an iPad®. Online references will be saved to the user's account. Most recent documents are shown at the top of the Resources list and previous documents are sorted into project folders. Documents (module (354)), spreadsheets (module (356)), web pages (module (358)) and references (module (360)) can all be stored, accessed and searched.

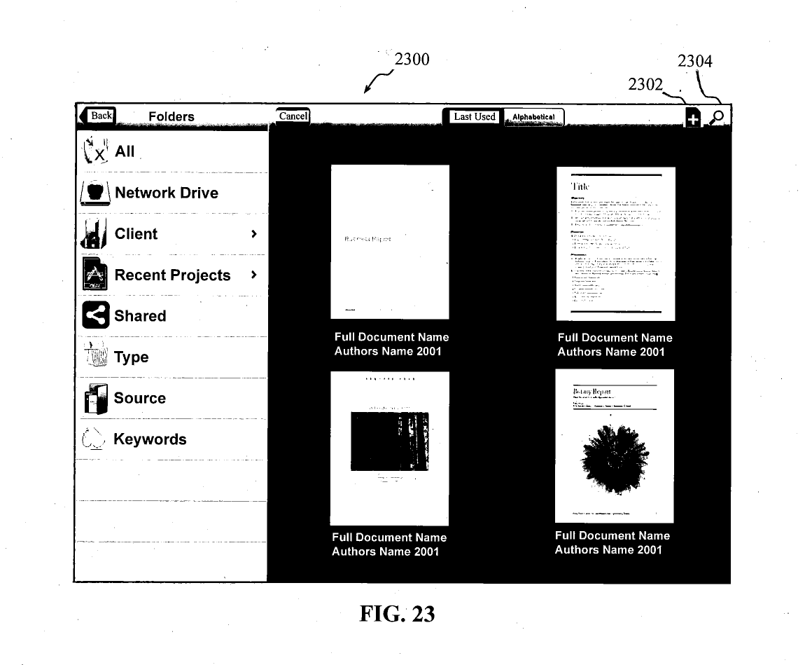

The Resources (504) can also be searched (box (353) at the top of the Resources menu) and the contents of each resource will be indexed. The results of the search will also have an option to search on various search engines, such as Google®. The search can be cancelled or changed using button (355). Once a resource is selected, it will open up the resource for review. It is then possible to edit the metadata as well as insert a citation into the composition. The “Add Web Page” button (363) allows a user to add more documents by a search, or browsing and downloading. A bibliographic reference can be added through button (365). A new screen appears in which information about the reference can be added such as the resource category (e.g. academic) and type (e.g. article), format (e.g. journal), the title including a short title, the name of the author and/or editor. Publication details can also be added such as article title short title, series volume series issue, page range, ISSN, the date and year of publication. The source of the reference may also be inserted with details such as the name (e.g. organisation), the place of publication, database, provider, URL, DOI, the date accessed, notes and keywords. Once the information is entered, it can be added to a project name and then an “Add Resource” button is pressed. Access to a file manager, called FileMate, is provided through module or button (364). FileMate will be described in further detail in relation to FIG. 23.

Button (444) in FIG. 4A provides access to the current document's history. There are also standard buttons in a block (446) to bold, italicise and underline text in a C-frame and in button block (448) to provide subscripts, superscripts and strikethroughs to any portion of the text in a displayed frame.

Writing C-frames (506) are created using basic C-frames to aid with common writing tasks such as adding an abstract, a title and an introduction. Clicking on button (414) produces the menu (506) shown in FIG. 5D. Essentially writing frames include, for example, a main title, sub-title, minor title, headings in three different positions, paragraphs in three different positions, list item in three different positions, a statement, quote, equation, formulae and data.

Multi C-frames are accessed by clicking on button (422) which produces a menu (508) shown in FIG. 5E. Multi composition frames have been designed by adding Writing C-frames together. These multi frames aid with the writing task and can be user defined. A range of multi C-frames will be identified for specific writing purposes, such as report, project plan, case study, academic essay and academic article. Multi frames can be any one of exhibit, list, table, figure, chart, source, hypothesis, proposition, paragraph (which can be linked to list item levels), heading (which can also be linked to different paragraphs), label, title, header, footer and author. The author can have several columns and data double columns in which to enter the author contact details. The multi C-frames include two or more consecutive C-frames linked together and are used for complex writing tasks, such as lists, tables, headers and footers.

Helper composition frames are accessed through button (416) shown in FIG. 4A. It produces the menu (510) shown in FIG. 5F. The Helper C-frames are a collection of Writing C-frames with instructions to aid in writing. They are used to provide, for example, an introduction, a structured abstract and a conclusion. The Introduction Helper C-frame provides linked C-frames including a heading, followed by four paragraphs frames for a situation, complication, question and answer, and composition outline. The Paragraph Helper C-frame includes four statement C-frames being point, reason, example and another point frame. The Conclusion Helper C-frame includes a heading, followed by the four Paragraph frames called Aims, Findings, Conclusions and Limitations. Finally a structured Abstract frame which is formed by 12 single column frames includes a first heading, a second heading, followed by two paragraphs repeated another five times. This is also used for a structured executive summary. Helper C-frames include ghosted writing to explain to a writer what is required. Ghosted writing disappears once a writer adds content to the frame. Another type of frame called a Saved frame is accessed by clicking on button (418), an example menu (512) is shown in FIG. 5G. It includes C-frames that contain saved content such as author name, contact details, person biography, or company overview.

Automatic or Auto frames (514) are compiled on data used in a composition as inserted from the Resources Database or the Terms Database. A user inserts the Auto C-frame in the location where the list should appear. For example, a list of abbreviations often appears in the front matter for a doctoral dissertation, whereas a glossary appears in the back matter. If an Auto C-frame is not inserted into the composition, then an Auto list will not be generated. However, the user can still utilise data from the Terms Database within their composition to aid with writing. Auto C-frames are used to provide lists, such as, symbols, references, glossary, abbreviations, acronyms, indices, table of contents, list of tables, a list of figures, a table of authorities, endnotes, footnotes and chapter notes. Automated lists are drawn from the data in the Terms database (312) as used in the composition. Auto C-frames are accessed by clicking on button (420) in FIG. 4A and an example of the screen that is subsequently shown is displayed on menu (514) in FIG. 5H. The various lists that can be automatically generated are table of contents, table of figures, table of tables, table of exhibits, table of authorities, list of abbreviations, list of acronyms, list of symbols, a glossary, a full index or a separate index for places, names (people), captions, endnotes, organisations and topics, a reference list and a bibliography list may also be provided.

Miscellaneous C-frames are shown in the menu (516) of FIG. 5J which is accessed by clicking on button (424). This menu includes a range of miscellaneous frame tags that allows the user to indicate certain fixed actions for example, forcing a page break, changing the document orientation or including a blank page.

As mentioned previously, clicking on button (444) provides a history about a document. It also allows a user to go back in time to different states and edits in the displayed document. The user can either copy text from the past or start editing, which will then put the new timeline at the end of the current timeline.

Clicking on button (432), the user is directed to a screen shown in the menu (518) of FIG. 5K. It enables the document metadata to be updated, including a full title, a short title, the client name, the project name and other metadata such as key words used in the document. This enables more efficient searching for documents.

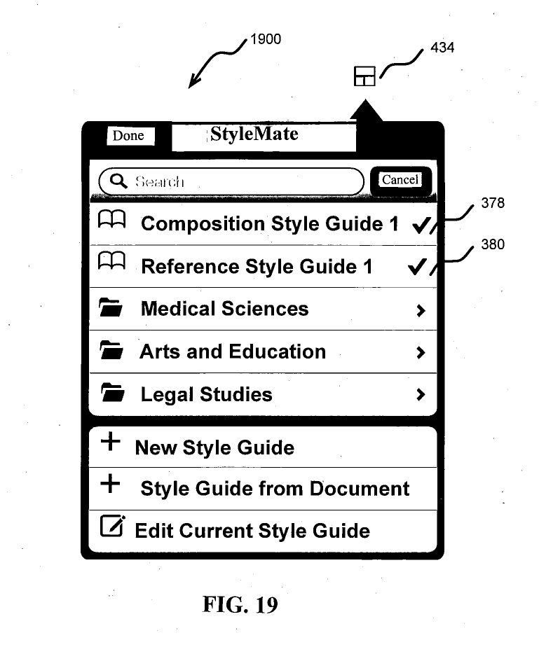

Accessing button (434) leads the user to the StyleMate Menu shown in FIG. 19 (to be described hereinafter). There are two types of style guides, being a composition (document) style guide and a reference style guide.

Clicking on button (436) directs the user to a screen shown in the menu (520) of FIG. 5L where the user can insert into the document text, bibliographic citations, cross references to other C-frames, resources, images, symbols, terms, names, Placeholders, media as well as a URL and a footnote. With regard to the citation, it shows the list of resources in the project, as well as those contained in the resources database. Upon selecting a resource, the citation is immediately inserted without having to open up the resource. A cross-reference can be inserted to other C-frames, like figures, tables and headings. With regard to a Placeholder, this is a textual Placeholder that automatically creates a “to do” Placeholder item and will remind the user in the outline view (via a diamond-shaped icon) that this needs to be attended to before the document is completed. With regard to footnotes, content can be added to be included in a footnote or endnote.

As mentioned previously, clicking on button (438) leads the user to the screen shown in FIG. 5A. It enables a series of views to be accessed, such as Outline View (modules (330), (332)), Preview View (module (334)), Writing Plan View (module (336)), My Documents (module (338)) and Templates (module (340)). Templates are shown in the order of when they were created, the newest being first. There are also pre-defined templates dependent on the field of study or work of the user, for example, an academic or business user and also what type of account the user has. It is possible to import documents using FileMate which can create style guides from an existing document.

FIG. 6 shows a screen (600) accessed through the Views button (438) and depicts the Writing Plan view. The Writing Plan screen (600) enables the user to plan his or her composition by adding, modifying, moving or deleting C-frames according to the standards of their discipline. Most document correspondence includes preliminaries (or front matter) which are entered into windows (604). These can include a cover page, table of contents, abstract or a list of authors. The body of the document is identified through window (606) which in this case is split into three separate windows (614), (616), (618). It positions C-frames in a structured manner, for example, “Introduction” is made up of a number of frames in window (614) and Key Points are shown in a further series of windows in each of the windows (616), (618). It can be seen compared to FIG. 4B that some of the frames in window (408) are transposed into window (606) of the Writing Plan screen to provide an alternative layout for the author or user to see and modify. Finally an Addenda (or back matter) is provided in window (608) that provides supplements or end matters such as references and appendices.

The Writing Plan is comprised of meta-frames and provides a background planning template on which to organise C-frames to ensure the overall composition meets the to user's aims. The Writing Plan gives a two dimensional overview of the document. Frames can be easily added and titles edited. Frames can also be nested within other frames, and the order changed by dragging, by first selecting the frame (which highlights the frame) and then adding a frame from the top left buttons (414) to (426). Heading sizes can automatically be determined and relationships can be established.

All frames have a ghost title based on the type of C-frame it is and content and titles can be altered in the Outline view. The colour of the frames are set by their current status as is set in the Task button (428). It is possible to touch scroll to the right of the screen to see more key points if necessary.

Saved frames ((512) in FIG. 5G), are accessed through clicking button (418), are frames that the user has used in previous documents like author, contact details and personal biography. Users can create their own Saved frames from standard frames that have a memory. Automatic or Auto frames, accessed through button (420) derive their contents from C-frames and terms in the document itself and can include index, table of contents, list of acronyms and bibliographic references for example.

Tasks are accessible through (418) while writers or reviewers are assigned to particular frames can be viewed through button (430). The assignees can choose to filter their frames or see what has been assigned to other people through this button. Once the user depresses the Done button (612), the frames are updated for the document.

Button (610) indicates or enables access to the Header and Footer C-frame module which is shown in window (522) of FIG. 5M. These are pre-filled, based on a previous project or can be created as new. It is possible to add extra parts to the Header and Footer, and depending on the Style Guide chosen for the document, it might be organised into equidistant columns concatenated together.

As mentioned previously, clicking on button (432) enables editing of the document metadata. On the first time showing of a new document, the document information is open, as seen in FIG. 5K. The user can then put in the document title as well as other metadata such as client and project. This data is then used to organise virtual folders in FileMate. The client is selected from clients who have already been added in the address book, or clients that are completely new. The project is selected from projects that have already been added or by adding a new one. The “See More” tab includes statistical information of the document including: version number, number of words, authors (which originally come from signing up information); styles in which it has been formatted and any other document level data that has been logged.

Shown in FIG. 7 is a screen (700) that represents a Preview view of the document shown in either FIG. 4B or FIG. 6. In window (702) there is shown the headings of each of the frames of the document and in window (704) there is a Preview view (706) of the actual document that can be scrolled up and down. The document can be edited in this view, however frames can only be edited in the Outline view (400) or the Writing Plan view (600). The Preview (704) shows the formatted output after the Style Guide has been applied to the complete document.

The miscellaneous C-frames (434) are otherwise known as C-tags whereby between composition frames a user requires the ability to add the next composition frame and indicate certain fixed actions, for example force a page break, or change the page orientation. This is undertaken through the use of special composition tags or C-tags located after each C-frame. The various instructions that the C-tag can perform include adding a new C-frame, adding a page break, adding a blank page, providing start columns, changing orientation of the page, adding a blank line, adding a line separator.

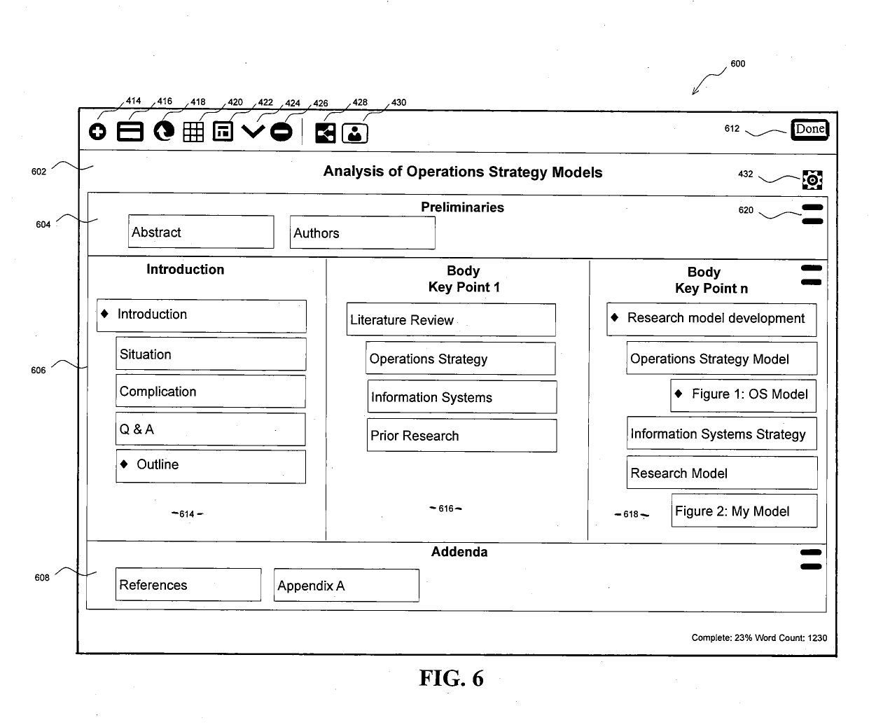

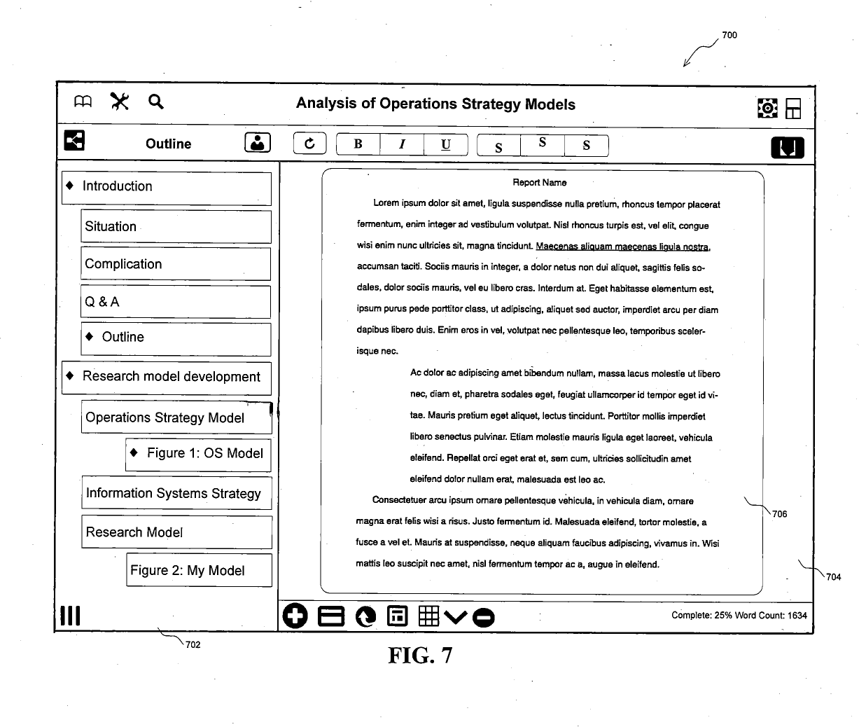

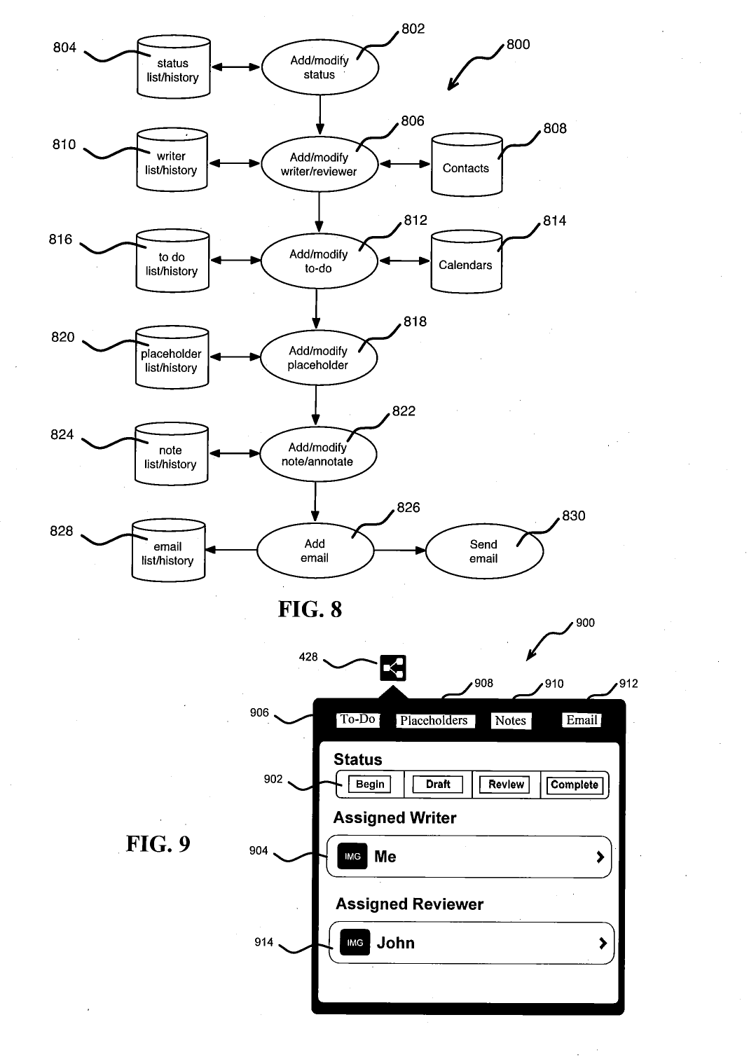

Referring to FIG. 8 there is a flow diagram (800) of Add/Modify Tasks (308) that can be associated with a C-frame or with an entire document. The status of a C-frame can be modified at step (802), the writer or reviewer can be added or modified at step (806), a To Do task can be added or modified at step (812), a Placeholder reminder can be added or modified at step (818), a note or annotation can be added or modified at step (822) and an email can be added at step (826). Each of these steps accesses the database or library (118) to respectively retrieve information on status list/history at step (804), Writer list/history at (810), “to do” list/history at (816), Placeholder list/history at (820), note list/history at (824) and email list/history at (828). At step (806) the Add/Modify Writer step can be retrieve a contact from a list of contacts in database (808) and the step Add/Modify To Do (812) can have access to a calendar database (814). At step (826) after adding an email, an email can be sent at (830). The message is sent via the user's default email service. After a To Do reminder is added, the system updates the user's calendar (814).

Shown in FIG. 9 is a window (900) of the Tasks associated with a C-frame. The status box (902) (module (342)) has buttons for Begin, Draft, Review and Complete that can be colour coded. The C-frame will be highlighted in this colour in the Outline and Writing Plan views. User-defined status labels can be also be added. A box (904) designates who the assigned writer/s is for the particular C-frame and box (914) indicates the assigned reviewer/s. At the top of the screen there are buttons (906) to go to the To Do reminders, and button (908) to access Placeholders, and button (910) to access Notes and button (912) to send an Email. The Tasks for a C-frame is accessed through button (428) shown in FIG. 4A.

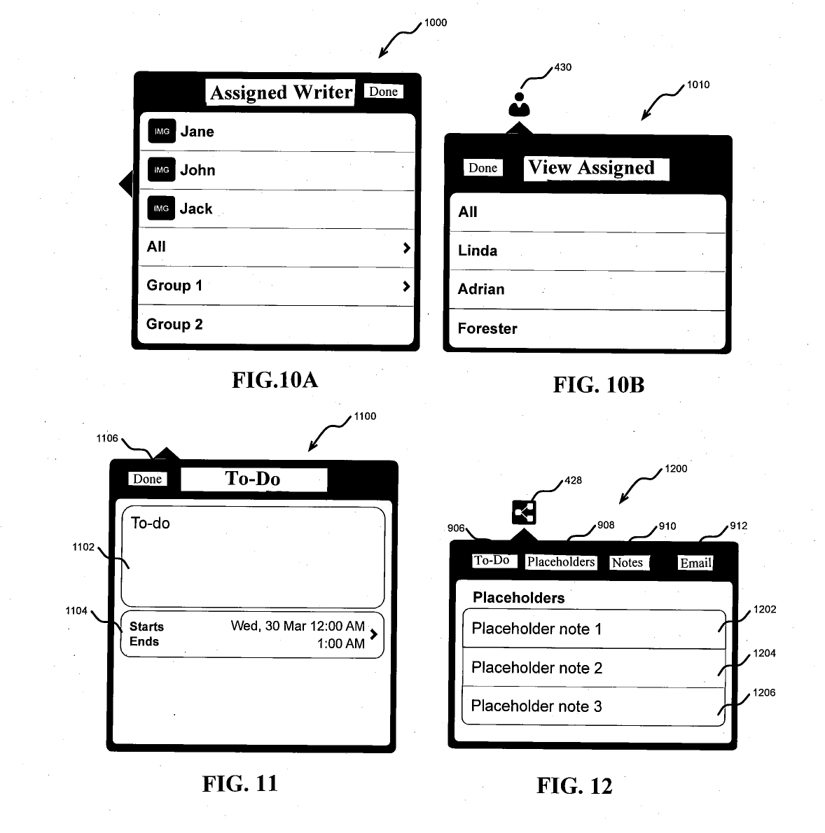

Shown in FIG. 10A is window (1000) (module (344)) accessed by clicking on the right hand arrow on tab (904) in window (900). One or more writers can be assigned to the particular C-frame and writers can be drawn from a predefined contacts database (808) that is shown in window (1000). A user can elect to see (and edit) the various views (Outline, Stack, Writing Plan, Preview) for a specific writer/reviewer or all writers/reviewers. Thus the writers Jane, John, Jack and the options All, Group 1 and Group 2 show various writers names in the database (808). In FIG. 10B, window (1010) is accessed through button (430) in FIG. 4A and allows the user to view all the assigned people for that particular C-frame.

Shown in FIG. 11 is a window (1100) accessed through button (428) (module (346)) and showing the To Do reminder. In particular, in window (1102) a To Do reminder can be inserted as well as updated in a defined calendar in the user's calendar system (814) or inserted within a document, for example, associated with a portion of text or an image. Multiple To Do's can be associated with a particular C-frame and/or a document. Once the To Do reminder has been entered in window (1102) and the start and end times and dates are inserted in window (1104), the user clicks on the Done button (1106) to go back to the previous menu. Alternatively, a due date for the required to-do can be entered as well as the name of a person the task is assigned to. Comments or notes can also be entered in the same window or a different window. A listing of all C-frame To-Dos can be viewed and edited for the overall composition.

Shown in FIG. 12 is a window (1200) showing the Task Placeholder (module (348)) and in particular shows the creation of a Placeholder. Placeholders are inserted into C-frames as a way of reminding a writer what they need to do associated with that particular C-frame. A range of system-generated Placeholders are available, for example “add a reference”, “add a figure”, “add a table”, “check with colleagues”. Users can define their own Placeholders, for example “ask Jenny”. When Placeholder notes are inserted into a C-frame, such as in window (1200) at tabs (1202), (1204), (1206), the list of Placeholders is automatically updated in the task list. The task of writing is to remove all Placeholders. A diamond (450) appears on the C-frame as well as the C-frame heading in the Outline view and the Writing Plan view when a Placeholder remains incomplete. Touching a placeholder will direct the user to the Placeholder in the current document view. Touching the Placeholder on the right side of the respective Placeholder tabs, it will allow the user to edit the assignment of that Placeholder. A due date, the name of the person to whom the Placeholder is assigned as well as any notes/comments can be inserted.

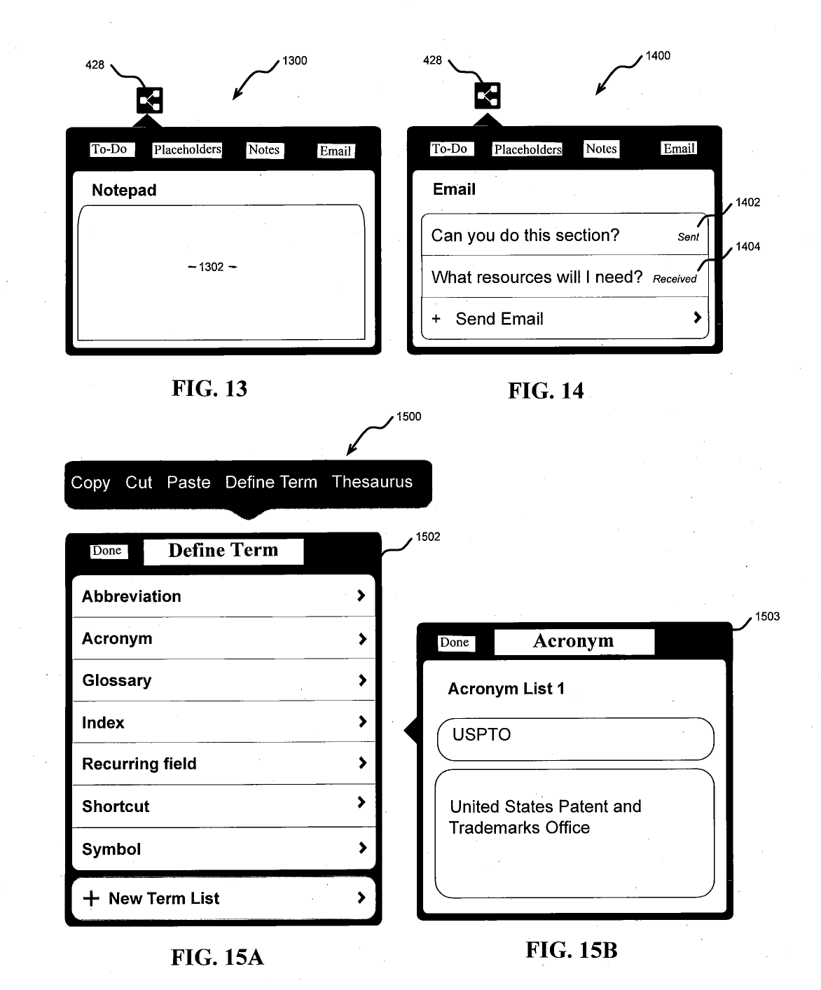

Shown in FIG. 13 is a window (1300) associated with a Task to Add/Modify Note (module (350)). It shows the range of notes or annotations that can be associated with a C-frame or a document. The user enters notes or annotations on his/her choosing as shown in window (1302). It provides the user with a means for adding a comment regarding the current composition. A comment might include details of an abstract that is related to the current work, some notes that remind the user on what to write or other personal notes. Annotations can be added in a similar way by a reviewer for the writer to attend to. A user can add, modify, delete a C-frame or composition Note or Annotation or mark it as complete. A listing of all C-frame notes and annotations, or selected by writer/reviewer, can be viewed and edited for the overall composition.

With reference to FIG. 14 there is shown the Task to Add/Modify Email whereby window (1400) is accessed through button (428) (module (352)). It shows a range of emails that can be associated with a C-frame or an entire document. It is possible to keep records of emails or other automated messages related to the C-frame or the document. Emails can be sent from this screen. The reply-to address will go to a parser unit first so that it can be added to this list and then forwarded onto the recipient's email address. Thus a question “Can you do this section?” is present in tab (1402) which can be sent to one of a number of email destinations. A further tab (1404) has inserted “What resources will I need?” which can be an inbound or received email asked of the person or user viewing the window (1400). Thus, the user is provided with a means for linking an email or other automated message to the current composition. The email might be to a collaborator, a reviewer or a journal editor. One can add, delete or modify an email, list emails (even by specific person) and add emails to a folder in the user's email account.

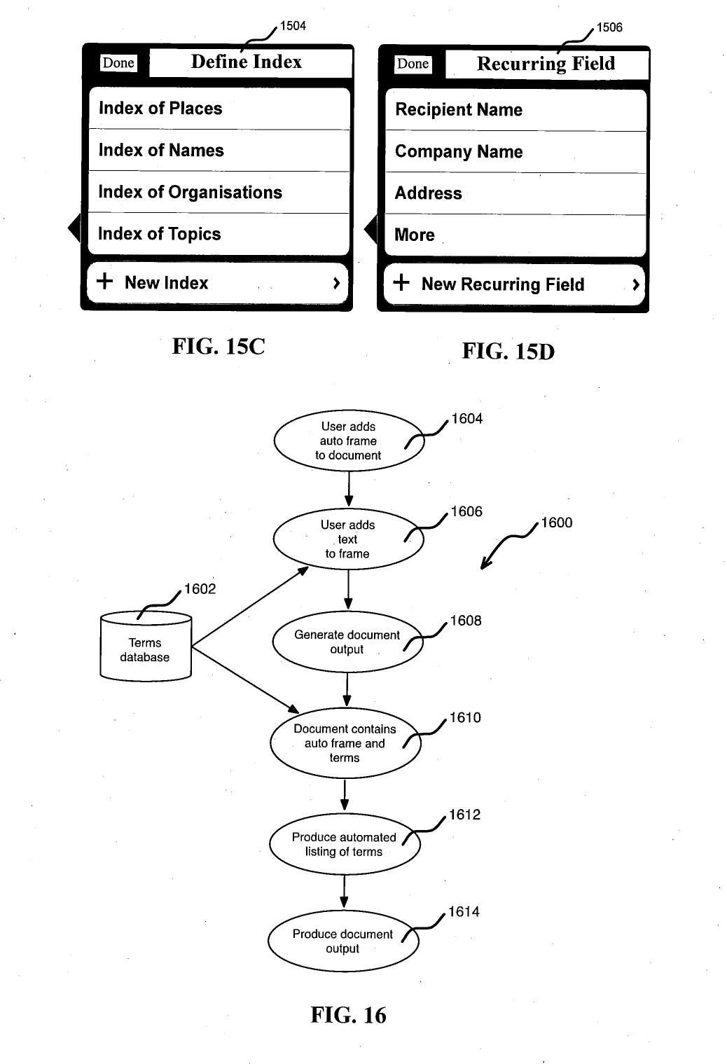

Referring to FIGS. 15A to 15D there is shown a series of screens or menu lists that are accessible when editing or composing a particular C-frame. These menus provide a way of defining Terms (312) and for accessing Terms within the database. When a particular word is underlined with either a green or a red line or is otherwise highlighted as indicating to the user that it needs replacing or amending, the user can place the cursor over that word which will trigger a drop down box or a box having various options to choose from. This is shown at box (1500) whereby the options are to copy, cut, paste, define a term or access a thesaurus. Other terms can be placed in box (1500) to access various databases. As an example, a word requires a further definition in which case the Terms database (312) is accessed by clicking on the Define Term menu option which produces the menu (1502). Various types of terms are accessible from the Terms database such as shortened forms, for example, abbreviation (module (366)), acronym (module (368)) and symbols (module (374)), a glossary (module (370)), or an index (module (372)), shortcuts (module (376)) and recurring fields. Shortened forms and long terms that get abbreviated are available to ease the reading process. For example, the term “Frequently Asked Questions” is shortened to “FAQ” in window (1503). When a long term is first used in a document, the full description is typed and the modified term, that is the acronym, is placed in brackets immediately following the full description. Thereafter the short form of the term can be used. This is the opposite process to shortcuts. A shortcut is a shortened way of typing a term to speed the writing process. For example, typing “(c)” is replaced with “©” or “USA” gets replaced with “United States of America”. A user can also define New Terms (in box (1502)), for example, a listing of Legal Terms and Conditions.

An Index contains a listing of frequently used words for example, topics, names, places and organisations. Typically, an index gets created when a document has been finished, for example a book. However, the user is able to maintain their own index of frequently used topic terms that can be accessed independently when creating or writing various documents. This will assist with the speed of typing and spell checking.

A Recurring Field is when specific data is required, for example the date, and may be inserted many times into a document. When the field is edited in the document frame, it automatically changes all fields of the same name to the same text.

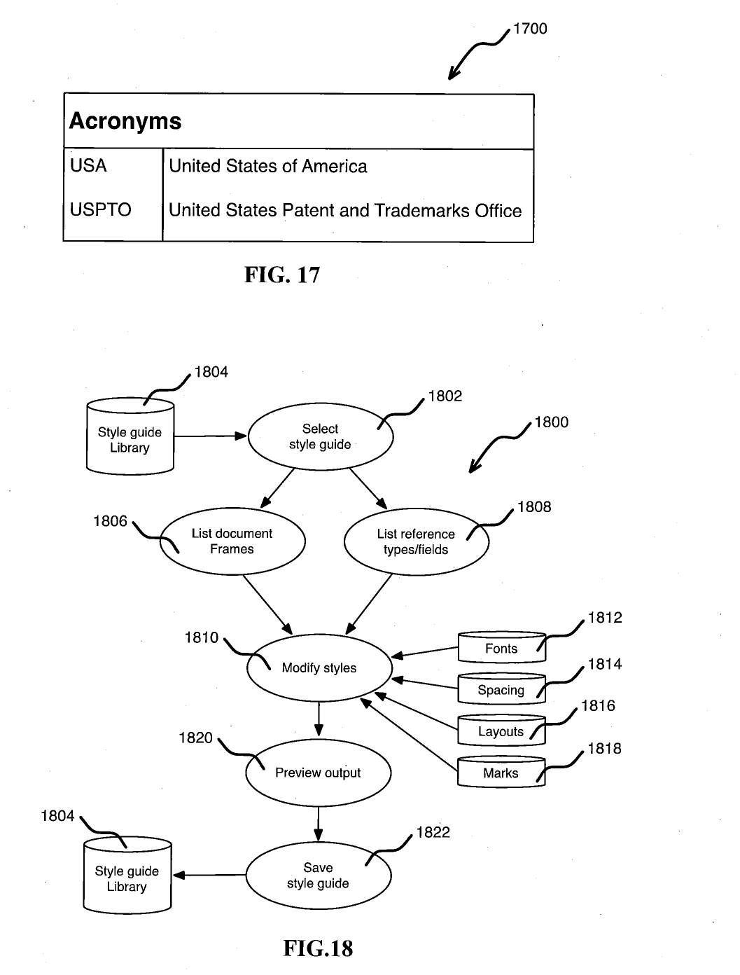

In FIG. 15B, when defining an acronym (window (1503)), abbreviation, symbol and glossary term, their long term meanings are also defined in addition. Re-defining can be done by reselecting the same word and bringing up the same contextual option. Automated listings of acronyms, abbreviations, symbols and glossary terms (514) draw on both the short and long form of a Term as shown in FIG. 17.

When text is being added to C-frames, the Terms database (312) provides a look up for words as the user types, thereby speeding the typing process and ensuring spelling is correct. The user-defined list of Terms can be created. Official lists of special terms will be provided, for example stock exchange list of organisations, or a list of fundamental chemical elements. In FIG. 15C, the Define Index window is shown at (1504) and in FIG. 15D the Recurring Field screen is shown at (1506). An example of an Acronym screen is shown at window (1503) by clicking on the menu item Acronym in menu (1502). The Done button is pressed when the user has finished modifying or editing or inserting a particular Term.

With regard to Terms generally, when words are selected, not only can they be copied and pasted, but they can also be included in one of the user's indices as shown in FIG. 15C. This is shown in screen (1504). A user can also define a New Index category (screen (1504)).

These indices are specified in the Terms database (1602) and are carried from document to document, stored in the user's account. Even though words are carried from document to document, if they do not appear in the current document then they do not appear in any automated C-frame listings. It will also be possible to add predefined industry or discipline specific indices.

The Terms database (1602) provides the user with the ability to add, modify or delete pre-defined content to use in a C-frame. Each composition Term category is a database of Terms and descriptions. Auto Lists can be generated within a composition for most kinds of composition terms (except shortcuts). When the composition gets compiled, the auto list forms part of the output file where a composition frame marker (Auto List C-frame) has been located in the composition outline.

The Terms database (1602) provides the ability for a user to maintain, or acquire, lists of words and terms frequently used in typing. The term (not a description) is drawn upon when entering text within a C-frame, except for shortcuts, where the term is typed and is replaced by the description. It provides the user with access to a system-wide data set of various terms, abbreviations and acronyms. With regard to abbreviations, an entry can be for a salutation, a business term or a medical term for example. The dataset has a number of columns being category, abbreviation and description. The composition text draws on the abbreviation, but does not replace it with the full description.

With regard to acronym as with abbreviation they can be added, edited or deleted. Acronym entries are categorised by a user-defined label and the dataset has a range of columns being category, acronym, and description. The composition text draws on the acronym, but does not replace it with the full description.

Names can be added to the Terms database (1602), such as names of people, places and organisations. To add a person, the name type person is selected from a drop-down box, then the first, middle and surname are entered. A reference can also be added and then an “Add” button depressed. To add a place, the name type place is selected from a drop-down box, then the place name is entered. A reference can also be added and then an “Add” button depressed. To add an organisation, the name type organisation is selected from a drop-down box, then the organisation name is entered. A URL and a reference can also be added and then an “Add” button depressed.

With regard to glossary this can be added, edited and deleted from or to the composition. Glossary entries are categorised by a user-defined label and the dataset has a number of columns being category, term, definition and bibliographic reference (which is optional). The text draws on the glossary term but does not replace it with the full description.

With regard to index, again this can be added, edited and deleted to or from the composition. Index entries are categorised as names, places, organisations and topics as well as sub-topics. Users can source text from this list to ensure correct spelling, or avoid typing frequently used text, without having to add an Index List to their composition. Adding an Index List requires adding an Index Auto C-frame to the outline. The dataset has a number of columns being category, term and sub-term.

With regard to symbols, again these can be added, edited and deleted and symbol entries are categorised by a user-defined label. The dataset has a range of columns being category, term and definition and the composition text draws on the symbol but does not replace it with the full description.

With regard to data fields, the date and time (with different formats), number (with different formats), document information (for example page count, character count, author and filename) can be amended or included. Numbers can be inserted into C-frames to use for page numbers and caption numbers (sequence is retained based on the C-frame (for example table, figure, page number, hypothesis, proposition)). There are a number of columns being category, field and description.

Finally shortcuts can be edited, added and deleted to or from the composition. The shortcuts allow the user to create a quick way of typing something in order to save time. Other shortcuts include symbols and text substitutions. The user types the shortcut but the full phrase replaces what they typed as they type. Shortcut entries are categorised by a user-defined label and the dataset has a number of columns being shortcut, term and phrase (or category, shortcut and Replace With). The user could also use Index to include frequently typed terms.

With reference to FIG. 16 there is shown a flow diagram (1600) of the process for producing an automatic listing of a Term. The Terms database (1602) is accessed after a user adds an auto frame to the document at step (1604). The user adds text to the frame at (1606), calling on the Terms database (1602). At (1608) a document output is generated and at (1610) a document contains an auto frame and terms. At step (1612) an automated listing of terms is produced and at step (1614) the document output is produced.

Shown in the box (1700) of FIG. 17 is an example of an automatic list of an Output view of acronyms and their description. The list is automatically generated based on the fact that the Acronym C-frame is present, the “term” is found in the document and it corresponds with a term in the Terms database. This output is typical for providing a list of abbreviations, acronyms, symbols and a glossary required in a range of academic and business documents.

Referring to FIG. 18, there is shown a process (1800) in which a user can select a particular Style Guide in order to provide a composition in the style of, for example, a target academic journal. It describes the process for creating both a composition (document) Style Guide and (bibliographic) Reference Style Guide. At step (1802) the Style Guide is selected from a list of pre-existing Style Guides in Library (1804) or a new style guide. At (1806) the list of document C-frames is provided from the current document while at (1808) a list of reference types and fields is provided. The user at (1810) modifies the various styles having regard to various formatting techniques such as fonts at (1812), spacing at (1814), layouts at (1816) and marks at (1818). The output is then previewed at step (1820) and the Style Guide is saved at (1822). The saved Style Guide is then returned to the Style Guide Library (1804) for storage.

A style can be created, shared among other users, imported from another source or document, exported to another source or document, or deleted using tabs/buttons on a selected screen. Existing styles that have been created may be displayed in order of most recent use or date of creation, to be used in the current document or frame.

A style can be selected from a tab on the screen and applied to certain parts of the document, such as a cover page, a header or footer, the body of the document, to references or to “smart lists”. Each style can include the type of font, character size, line spacing, bolded text, underline, italics, text alignment. Smart lists can include a table of contents, a list of captions, a glossary, an index, abbreviations, names (person, place, organisation), footnotes and footnotes as endnotes. A format for the table of contents can be created including the numbering style and the number of levels to be shown, selectable from drop-down boxes. Indentations can be selected from a drop-down box and selected at for example, the first line of each paragraph. Footnotes can also have particular characteristics such as including brackets and footnote markers.

Once the style has been completed, the document (or project) can be exported as a Word document or a PDF document. It can be exported in a particular style, where no style has been created for that document.

FIG. 19 shows a menu (1900) which is accessed by clicking on button (434). It relates to the StyleMate screen (module (314)) of which there are two types of Style Guides, Composition (or document) style guides (module (378)) and References style guides (module (380)). The screen (1900) can also be used to add a new Style Guide or add a Style Guide from a document. Style Guides can be stored according to various disciplines or categories, such as legal studies, arts and education and medical sciences. The StyleMate selector, as depicted in FIG. 19, shows a history of Style Guides that have already been used in the current open document (378), (380). Furthermore the user can browse folders or search for Style Guides from a predefined library for different academic disciplines, for example medical sciences. Selecting a Style Guide will automatically put the document into a preview mode so that the user can view the style. Selecting Style Guide from a document will bring up the FileMate menu so that one can select a resource of type document with an attempt to derive a Style Guide from the document.

With reference to the Composition Style Guide, this provides the user with a means for maintaining the format of their composition independent of the writing. Essentially each C-frame, as captured content, offers the ability to format the content as a discrete activity. Advantages include that each kind of C-frame will have consistent formatting and reduce the need for spending large amounts of time reformatting when, for example, an academic journal article is sent to a different journal. The StyleMate icon provides information about the current Style Guides in use (Composition Style and Reference Style), the ability to select a different Style Guide and a link to go to the StyleMate to make changes if required. A default Style Guide is available and can be updated by the user if required.

With regard to Composition Style Guide, when a particular Style Guide is selected at step (1802), the system generates the Composition Style based on the composition frames used. Many Style Guides can be deployed for a single composition, at different times, and can be invoked by the user by selecting the Style Guide they wish to use for a particular output file. Each C-frame within the composition will have a default Style Guide to ensure that a style is available for every composition frame used. A user can format all of the selected C-frame types, for example Heading 1, Paragraph 1, to create the default for that C-frame type or select a specific instance of a C-frame to create a unique style for the selected C-frame. The Viewer can be opened to view the composition as formatting decisions are made. The user can identify their preferred default format for each category.

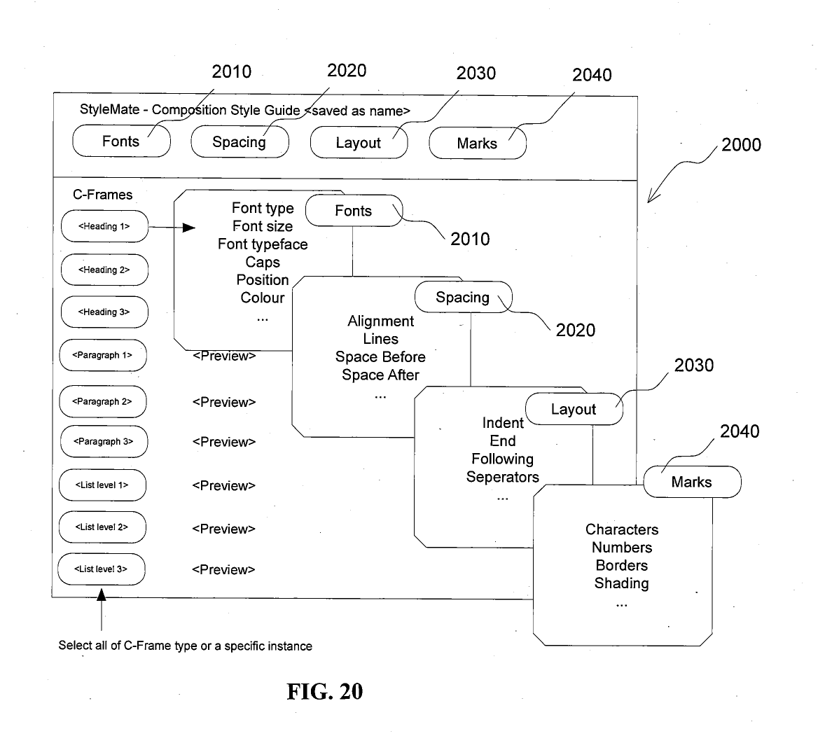

Shown in FIG. 20 is a screen diagram of an outline of the Composition Style Guide requirements. The screen (2000) provides access to four different sub-menus being Fonts (2010), Spacing (2020), Layout (2030) and Marks (2040). Each of the C-frames in the current document are shown on the left hand side of the screen (2000) via each heading. By clicking on each of the buttons, the text within that heading can be seen. Previews can also be viewed. Thus the user will select the C-frame type or a specific instance and have access to the buttons (2010), (2020), (2030), (2040). By clicking on button (2020), which brings up font options, the user can select from, for example, the range of font type, font size, font typeface or style such as regular, bold, italicised. The user can also select whether or not certain parts of the text are to be in capital letters and select the colour applied to any or all parts of the text from a colour pallet. The selection is done in a spreadsheet style, whereby selection of a cell displays (at the bottom of the screen) the possible options, for example, what style font. The frames are listed in the first column, and selection of an entire column from the first row will enable the editing of everything in that column. As a row is selected, a Preview View is shown directly beneath it. All C-frames can be edited from this style guide (including Auto C-frames).

Clicking on button (2020) enables access to the Spacing sub-menu whereby line spacing, alignment, space before and space after can be selected from. Accessing button (2030) provides Layout options (such as paragraph, indent all, indent first, no indents), how far the indent is to be defined, providing an end (such as full stop, colon, semi-colon, blank space, then the word, and none). A following option is also provided, that is “continue on the same line” or the “next line” and access to separators is also provided. Clicking on the button Marks (2040) enables the user to provide specific characters for marking footnotes, endnotes, paragraphs and lists, all sourced from a symbol data set. It also provides access to different types of numbers, shapes and size for identifying lists, the user can select which number to be used for each level. The user can also access Line Style including different line thicknesses and line position, for use in headers and footers and tables.

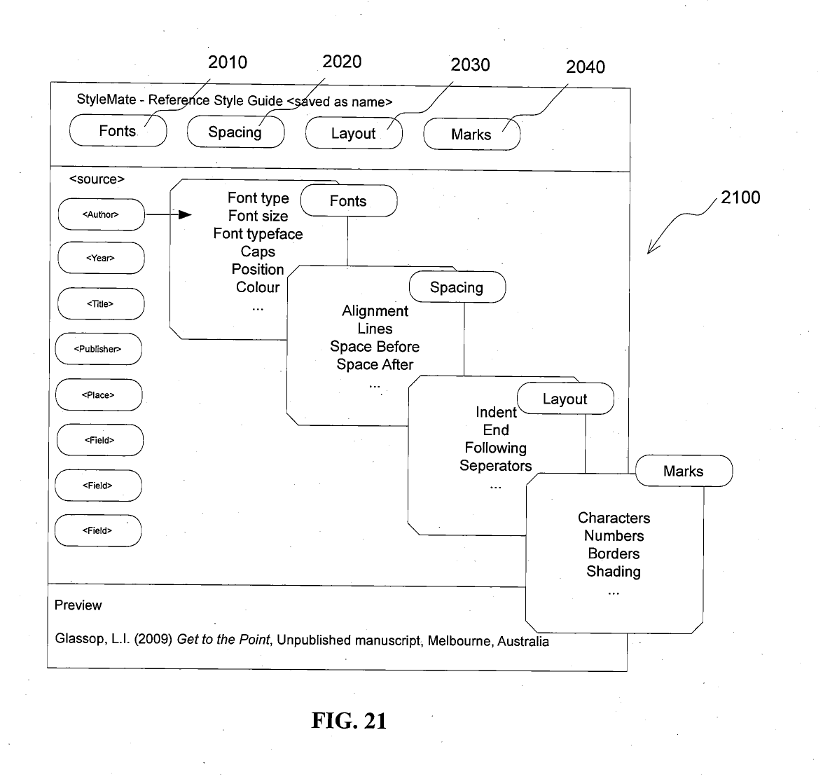

StyleMate also enables the editing of all the different types of bibliographic references (for example, journals, book, chapter) that could be used in a document, which can be directly edited via their attributes in a spreadsheet style. Shown in FIG. 21 is a screen diagram (2100) of the references style guide requirements. The reference style guide holds the format for all academic journals, as provided by journal editors. There are various reference sources such as book, book chapter, journal article, article in magazine, conference proceedings, report, website, case, legislation, statutes. Each source requires different fields to be collected. Each data field for each source will be a discrete C-frame, and provided in a list that the user can drag into a different order. The user can then utilise the StyleMate menus (2010), (2020), (2030), (2040) to format each field as they require, for example to comply with a specific journal requirement. The screen (2100) is similar in view to screen (2000) in that it has access to attributes such as fonts, spacing, layout and marks. However on the left side of screen (2100) there are various headings for C-frames entitled author, year, title, publisher, place and other fields for the user to complete or modify. Reference fields are concatenated horizontally in the Preview view. A Preview View is shown directly beneath it. When the type of reference, for example a book, is selected at <source> in screen (2100), the fields associated with that reference type are provided in the column below. All reference source types can be edited from this style guide.

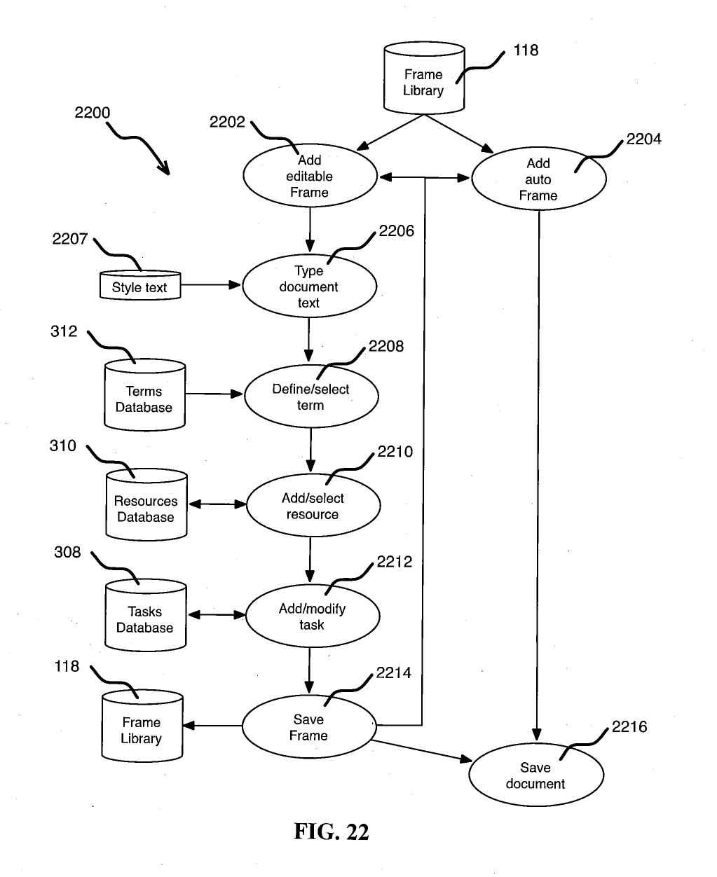

Referring to FIG. 22 there is shown a flow chart (2200) of the activities associated with composing or writing and editing a document. An editable frame is added to the composition at (2202) or alternatively an auto-frame is added at (2204), each from the frame library (118). Next at step (2206), the document text is added, which may draw upon a limited range of in-text styling (2207) and at (2208) a term or terms can be defined and selected from Terms database (312). At step (2210) a Resource can be added or selected and at step (2212) a Task is added or modified using a Tasks database (308). At step (2214) the C-frame is saved and saved back to the frame library (118) and the document is saved at (2216). Furthermore when an auto-frame is added at (2204) this is directly saved into the document at (2216).

With reference to FIG. 23 there is shown a screen (2300) which is accessed through the FileMate icon or tab. FileMate is the name given to a file manager which manages files in a users account and on the users computing device, such as an iPad®. The file manager is used to manage documents, resources, importing styles for the style guide module (314) (StyleMate), inserting media and spreadsheets. Document thumbnails are created from the most unique page of the document which would typically have an image, graph or table. It is possible to import other documents from a network drive. Upon importing, the system extracts out a style guide as well as breaks the content into C-frames. Furthermore it is possible for folders to have sub-folders and the structure of each is shown below, unless it is a single level sub-folder:

Client>Folders of Clients>Folders of Projects

Recent Projects>Folders of Recent Projects

Type>Folders of File Types

Source>Folders of the source of the resource

Keywords>Folders of each Keyword taken from words that are used in the documents index.

As the user creates new documents and fills in the metadata, the system automatically creates sub-folders in each of the above mentioned sections related to that metadata. For example, if the user inserts the client and a name for the project, a sub-folder of this client would appear in the Clients folder. Within this sub-folder would be the project sub-folder.

Icons on the top right hand side of screen (2300) include button (2302) which enables the creation of a new document, which then jumps to the templates screen. Button (2304) enables a search to be done for an existing document.

The file manager FileMate will be a simple file uploader which will come as an application installer. Files can simply be dragged into the drive, or even emailed to a system address and these files can be accessed by the FileMate screen. Once they are added to the project, they are automatically organised into that project folder. The File manager will also include a real time export of project documents in various formats. It is possible to have bibliographic references imported from other Applications and those references will appear in the FileMate menu as References.

A Dashboard can be accessed through the program that provides a screen to the user with an update on the status of a particular project. Archived projects can also be searched. Each project displayed shows the due date, latest version number, when it was last edited and by whom, percentage of completion and word count. Also shown on the Dashboard screen is a list of projects that are due to be completed within a particular timeframe, for example, within 30 days. All recent activities carried out on current projects are listed in an Activity window.

A new project can be created from this Dashboard page, by clicking on “New Project” tab. At the top of the screen the user can access Resources, Project Templates and Styles. When starting a new project, the user is directed to a screen to input information including Title, Category, Type and Format (under reference data), the Project Template, Style, Target Word Count and due date. Once this information has been entered, the user clicks on the “Start Project” tab.

1. A method of creating a structured word processing document that is arranged in a specific format, the method comprising the steps of:
opening the document to be processed in one of a plurality of view types;
creating one or more composition frames (C-frames), each C-frame containing data inserted by a user and selected by the user based on the use of the C-frame within the structured document;
displaying the one or more C-frames on a screen to enable editing or ordering of each C-frame to compose the structured document; and
formatting the structured document to a predefined format after completion of the C-frames.

2. A method according to claim 1 further comprising naming each C-frame and displaying the name of each C-frame on a portion of the screen to enable the user to select and display a desired C-frame.

3. A method according to claim 1 wherein the one or more C-frames are selectable from a range of types; for example, basic writing frames, helper frames, saved frames, automatic frames, multi frames and miscellaneous frames, said types of frames being selectable through a respective button, tab or module displayed on a screen.

4. A method according to claim 1 further comprising displaying the status of one or more C-frames and coding each of the C-frames to indicate said status.

5. A method according to claim 1 further comprising assigning one or more writers and/or one or more reviewers to a C-frame, such that said one or more writers and/or one or more reviewers are responsible for the content and completion of the C-frame.

6. A method according to claim 5 wherein a user is able elect one of the view types of a C-frame assigned to a specific writer, a specific reviewer, a number of writers or a number of reviewers.

7. A method according to claim 1 wherein the plurality of view types includes an Outline View in which the name of each C-frame is displayed in a first window and a Stack View in which the content of selected C-frames is concurrently displayed in a second window.

8. A method according to claim 1 wherein the plurality of view types includes a Writing Plan View in which C-frames are displayed horizontally across the screen to enable a user to plan the structure of the document including editing and moving the C-frames.

9. A method according to claim 8 wherein the Writing Plan View includes a Preliminaries window to structure the start of the document, a Body window in which the C-frames are displayed and arranged according to sections of the document and an Addenda window to structure the end of the document.

10. A method according to claim 1 wherein the plurality of view types includes a Preview View in which the user is able to preview the compiled document in said predefined format.

11. A method according to claim 1 wherein the plurality of view types includes a Stack View in which the user is able to view all C-frames in a sequential order, add, edit and change the order of the one or more C-frames.

12. A method according to claim 1 further comprising enabling the creation of updating of a “to-do” reminder to prompt the user to undertake a particular action associated with a specific C-frame or the whole document.

13. A method according to claim 1 further comprising enabling the user to create or modify a Placeholder reminder which is inserted into a C-frame to remind the writer or a user to undertake an action particular to said C-frame.

14. A method according to claim 13 wherein the document is not completed until all Placeholder reminders inserted in the C-frames have been marked as complete.

15. A method according to claim 14 wherein a Placeholder reminder is indicated by indicia on the title or name of the C-frame.

16. A method according to claim 1 further comprising accessing a Terms database while a user or writer adds text to, adds other data to, reviews or edits a C-frame, said Terms database providing the user the ability to add, modify or delete identified content in the C-frame.

17. A method according to claim 16 wherein the types of terms in the Terms database include shortened forms, indices, shortcuts and recurring fields.

18. A method according to claim 17 wherein the shortened forms include any of abbreviations, acronyms, glossary and symbols.

19. A method according to claim 17 wherein the indices include any index of places, names, organisations and topics.

20. A method according to claim 17 wherein a box appears on screen when text or data to be edited, modified or added is selected by the user in the C-frame, said box providing access to the terms in the Terms database.

21. A method according to claim 1 wherein the formatting step includes selecting a style guide from a database of style guides, each style guide being representative of a document style for a target journal, profession or organisation, whereupon the document is displayed in a Preview View.

22. A method according to claim 21 whereupon selecting a style guide either (a) in the case of a composition style guide, a composition style based on the C-frames selected is generated or (b) in the case of a bibliographic reference style guide, a set of data fields is collected for each reference source used and a data field is able to be applied to the identified references.

23. A method according to claim 22 wherein the user is able to modify or format each style guide using a variety of formatting techniques, for example: fonts, spacings, layouts and marks.

24. A computer-readable medium comprising computer-executable instructions that, when executed on a processor, in a method of creating a structured word processing document that is arranged in a specific format, directs a device to:
open the document to be processed in one of a plurality of view types;
create one or more composition frames (C-frames), each C-frame containing data inserted by a user and selected by the user based on the use of the C-frame within the structured document;
display the one or more C-frames on a screen to enable editing or ordering of each C-frame within the structured document; and
format the structured document to a predefined format after completion of the C-frames.

25. A system for creating a structured word processing document that is arranged in a specific format, said system comprising:
a server having a processor and memory for storing computer-executable instructions;
one or more computing devices linked to said server through a communications network;
wherein a user or users of said one or more computing devices are able to access said server to create said document by:
creating one or more composition frames (C-frames), each C-frame containing data inserted by a user and selected by the user based on the use of the C-frame within the structured document;
displaying the one or more C-frames on a screen to enable editing or ordering of each C-frame within the structured document; and
formatting the structured document to a predefined format after completion of the C-frames.

26. A method according to claim 1 further comprising saving the data of said one or more C-frames and using the saved C-frame and data in another document.

27. A method according to claim 1 further comprising providing a list of outstanding tasks associated with a document, a range of documents, a writer or a reviewer.

28. A method according to claim 27 wherein the outstanding tasks includes any one or more of status, placeholders, to-do reminders and assigned writers or reviewers.

29. A method according to claim 1 further comprising automatically generating lists where auto C-frames are located within the document.

30. A method according to claim 29 wherein the lists may be any one of acronyms, abbreviations, symbols, glossary, index, contents, tables, figures, authorities, bibliography, and references.

31. A method of notating a document electronically by a user while reading the document, comprising the steps of:
accessing and displaying in a first window the document for notation on an electronic display means;
selecting a portion of the document;
providing in a second window associated with the selected document portion, one or more links to characteristics of the selected document portion; and
displaying each characteristic for viewing, editing or notating by the user.

32. A method according to claim 31 wherein the characteristics are any one of highlighted portions of the document, quotes from the document, paraphrases by the user or comments by the user.

33. A method according to claim 31 wherein the characteristics are displayed in a third window.

34. A method according to claim 32 wherein one of the characteristics is rank, said rank being associated with any one or more of highlighted portions of the document, quotes from the document, paraphrases by the user or comments by the user.

35. A method according to claim 32 wherein one of the characteristics is use associated with any one or more of highlighted portions of the document, quotes from the document, paraphrases by the user or comments by the user, said use being input by the user.

36. A method according to claim 31 wherein the document is a resource document accessed from a resources database using a resources screen displayed on the display means.

37. A method according to claim 36 wherein the resources database includes a personal database of resources of the user residing in one or more categories.

38. A method according to claim 37 wherein the personal database is searchable within said one or more categories and based on other characteristics of the resources.

39. A method according to claim 37 including searching for new resources using links to either the internet, other databases or a scholar database.

40. A method according to claim 36 further including selecting the document to enable the display of the document in the first window, said document including basic information pertaining to the document.

41. A method according to claim 31 further including displaying on the display means a Notebook section used to display information about the selected document under one or more tabs including a reference tab, a notes tab and a tags tab.

42. A method according to claim 41 wherein the reference tab displays information about the document including bibliographic information, said information being editable by the user.

43. A method according to claim 41 wherein the notes tab displays, in relation to a selected portion of the document, highlighted portions of the document, quotes from the document, paraphrases by the user or comments by the user, rank and a use of each of said highlighted portions of the document, quotes in the document, paraphrases or comments, each of these characteristics being editable by the user.

44. A method according to claim 41 wherein the tags tab enables display and editing of any one of projects, topics and annotation of the document by the user.

45. A computer-readable medium comprising computer-executable instructions that, when executed on a processor, directs a device to perform any one or more of the steps of claim 31.
